(19) United States
(12) Patent Application Publication
(10) Pub. No.: US 2026/0072173 A1
(43) Pub. Date: Mar. 12, 2026

(54) SYSTEMS AND METHODS FOR COUNT-FREE HISTOGRAMS IN 3D IMAGING

(71) Applicant: Portland State University, Portland, OR (US)

(72) Inventors: David Maier, Portland, OR (US); Atul Ingle, Portland, OR (US)

(21) Appl. No.: 19/108,705

(22) PCT Filed: Sep. 7, 2023
(86) PCT No.: PCT/US2023/073682

§ 371 Date: Mar. 4, 2025

Related U.S. Application Data
(60) Provisional application No. 63/375,045, filed on Sep. 8, 2022.

(51) Int. Cl. G01S 17/894; G01J 1/44; G01S 7/4865

(52) U.S. Cl. CPC G01S 17/894; G01J 1/44; G01S 7/4865; G01J 2001/442

(57) ABSTRACT

Systems and methods are provided for count-free, equi-depth histograms that may be used in 3D imaging. In one embodiment, a method comprises receiving, at a binner, a stream of photon return events from a pixel of an imaging detector, the stream of photon return events generated by photons transmitted from a pulsed light source and reflected off an object in a scene, classifying, with the binner, each photon return event as either an early event or a late event based on a reference signal controlled by a control value, the control value configured to change based on a relative proportion of early events to late events, and outputting, from the binner, the control value upon request, the control value usable to determine a distance of the object in the scene.

### CROSS REFERENCE TO RELATED APPLICATIONS

This application claims priority to U.S. Provisional Application No. 63/375,045, entitled “SYSTEMS AND METHODS FOR COUNT-FREE HISTOGRAMS IN 3D IMAGING,” and filed Sep. 8, 2022, the entire contents of which is hereby incorporated by reference for all purposes.

### GOVERNMENT SUPPORT

This invention was made with government support under Grant No. 2138471 awarded by the National Science Foundation. The U.S. Government has certain rights in the invention.

### FIELD

The disclosure relates to equi-depth histograms (also referred to as equi-height histograms), and more particularly to equi-depth histograms captured by single-photon sensing 3D cameras.

### BACKGROUND

Single-photon sensing has recently emerged as a promising new technology for high-resolution 3D imaging. A single-photon 3D camera captures the round-trip time of a laser pulse by precisely time-tagging the arrival of individual photons at each camera pixel. Capturing photon timestamp histograms is a fundamental operation in single-photon 3D imaging. However, forming a standard histogram in each camera pixel is computationally expensive, consumes power, and requires large amount of memory within each pixel.

### SUMMARY

As discussed further herein below, various systems and methods are provided that significantly improve the computation of depth maps (e.g., distance maps) of an imaged scene using a single-photon-sensing 3D camera. In one embodiment, a method comprises receiving, at a binner, a stream of photon return events from a pixel of an imaging detector, the stream of photon return events generated by photons transmitted from a pulsed light source and reflected off an object in a scene, classifying, with the binner, each photon return event as either an early event or a late event based on a reference signal controlled by a control value, the control value configured to change based on a relative proportion of early events to late events, and outputting, from the binner, the control value upon request, the control value usable to determine a distance of the object in the scene.

In this way, distance of objects within an imaged scene may be determined without explicitly forming histograms in each pixel by using an adaptive approach for distance estimation in resource-constrained settings with limited bandwidth, limited memory and limited compute. The approach described herein constructs equi-depth histograms as opposed to the equi-width histograms of other methods. Equi-depth histograms are a more succinct representation for “peaky” distributions, such as those obtained by a single-photon detector from a laser pulse reflected by a surface. This approach builds on a binner element that adaptively converges on the median (or, more generally, to any other k-quantile) of a distribution. In some examples, multiple binners may be combined to form an equi-depth histogrammer (EDH) that can produce multi-bin histograms.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 schematically shows an example imaging environment including a time-of-flight 3D camera according to an embodiment;

FIGS. 2A and 2B are a circuit diagram for a binner and an outcome of the binner, respectively, according to an embodiment;

FIGS. 3A and 3B show a boundary of a binner at a relatively early-stage cycle in a run and at a relatively late-stage cycle in the run, respectively, according to an embodiment;

FIG. 4 shows convergence of a binner over a plurality of cycles of a run according to an embodiment;

FIGS. 5A-5D show convergence of three different binner configurations according to an embodiment at various combinations of signal strength and background light including a high signal, low background condition (FIG. 5A); a high signal, high background condition (FIG. 5B); a low signal, low background condition (FIG. 5C); and a low signal, high background condition (FIG. 5D);

FIGS. 6A-B shows a bin boundary output by a binner under low background light (FIG. 6A) and high background light (FIG. 6B), according to an embodiment;

FIG. 7 is a circuit diagram for a multi-stage equi-depth histogrammer (EDH) according to an embodiment;

FIGS. 8A-8G show boundaries output by an EDH across a plurality of cycles of a run, according to an embodiment;

FIGS. 9A-9D show the output of an EDH (with 16 bins), with low background and high background;

FIG. 10 shows example distance maps of two scenes using 8 bin equi-width and equi-depth histograms;

FIG. 11 shows example distance maps of a scene using 16-bin equi-width and equi-depth histograms;

FIG. 12 is a flow chart illustrating an example method for identifying a bin boundary of a transient distribution using a binner;

FIG. 13 is a flow chart illustrating an example method for identifying a plurality of bin boundaries of a transient distribution using an equi-depth histogrammer;

FIG. 14 schematically shows an example histogrammer coupled to multiple pixels of a detector;

FIG. 15 is an example circuit diagram showing an analog implementation of a control value; and

FIG. 16 shows an example circuit diagram showing a digital implementation of a control value.

### DETAILED DESCRIPTION

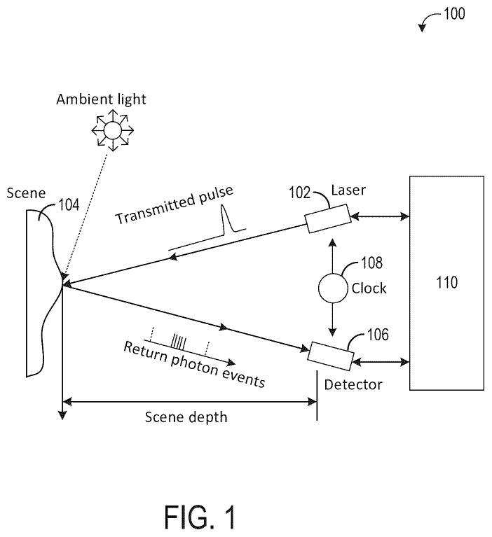

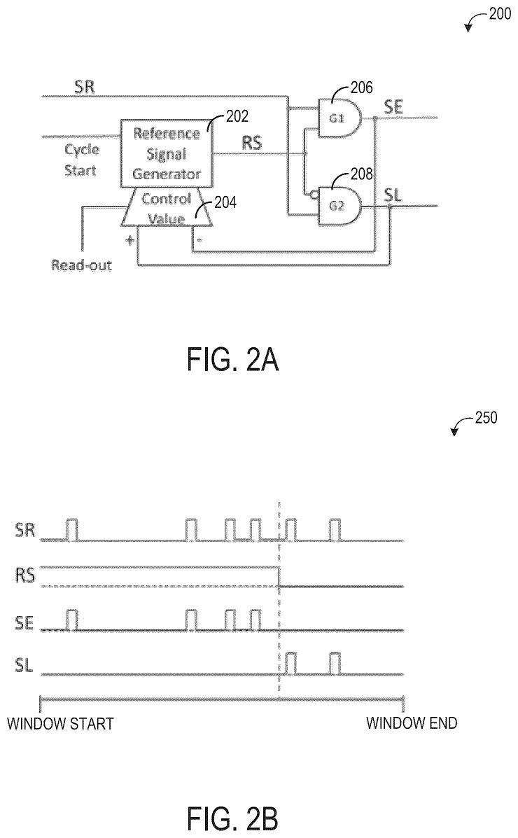

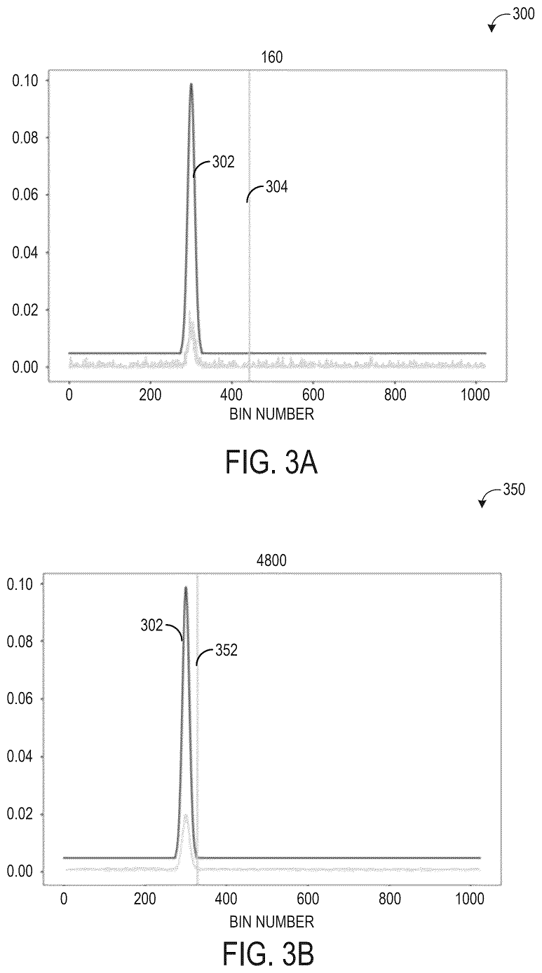

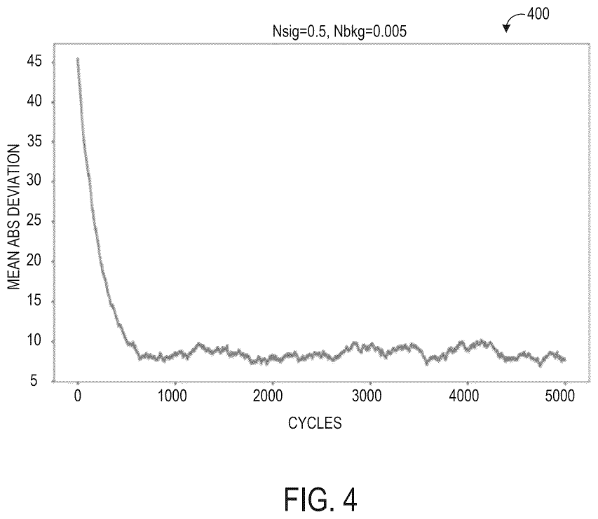

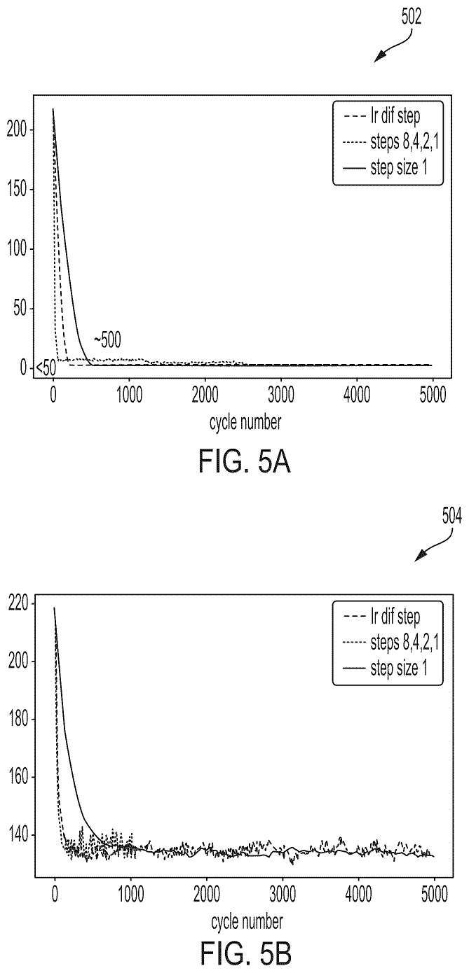

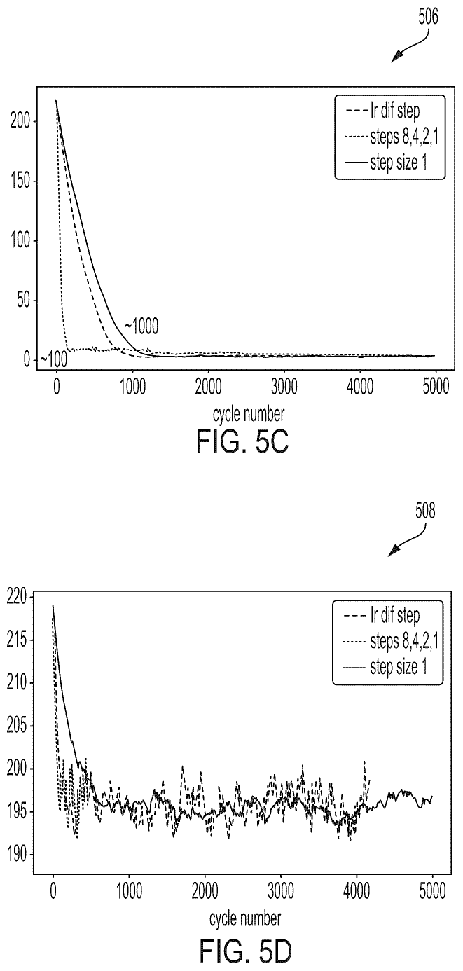

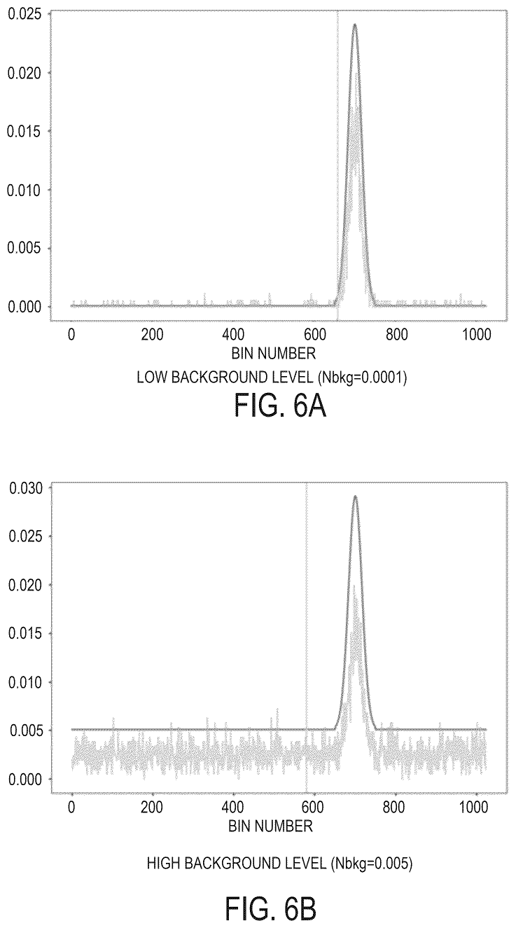

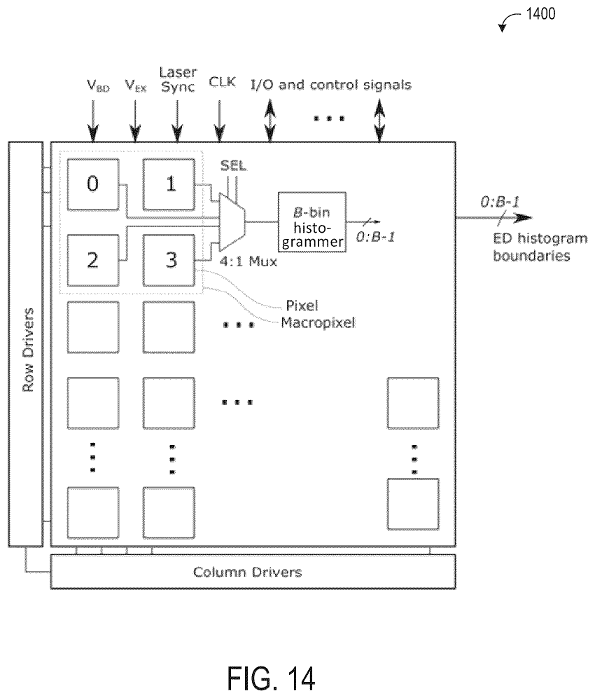

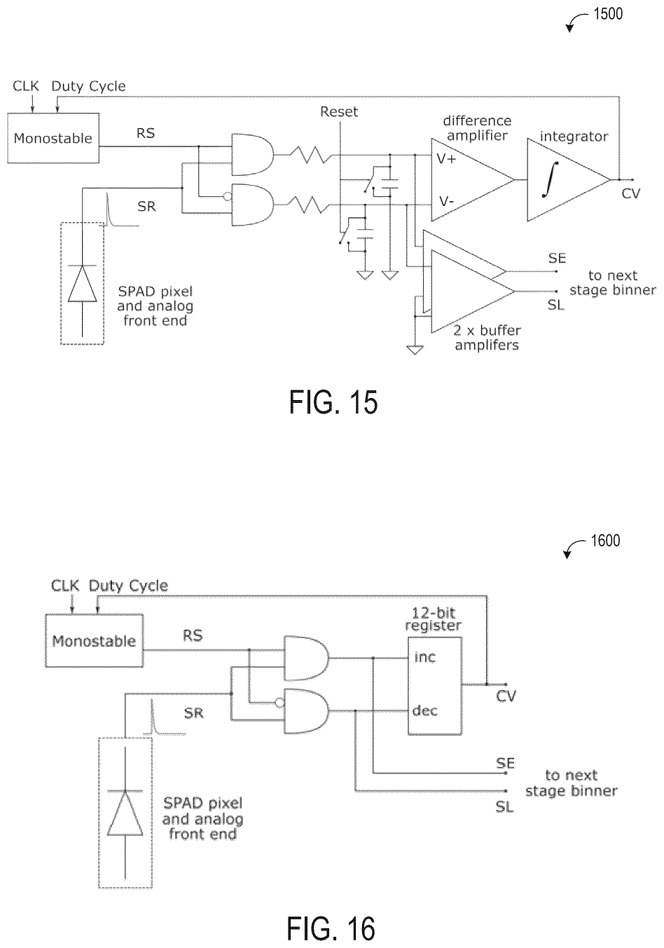

The following description relates to various embodiments of calculating distance (e.g., depth) of one or more objects in a scene imaged with a single-photon sensing 3D camera by employing equi-depth histograms. For example, as depicted in FIG. 1, a single-photon sensing 3D imaging system may include a pulsed light source and a detector positioned to receive photons transmitted from the pulsed light source and reflected off one or more objects in a scene. In particular, the detector may include a binner, such as the binner depicted in FIG. 2A, for each pixel (or group of pixels, as shown in FIG. 14) that may adaptively identify a bin boundary from a range (e.g., of delay times for photon return events) in a transient distribution. The binner may split a stream of photon return events into a late stream and an early stream based on a reference signal controlled by a control value (which may be implemented in analog, as shown in FIG. 15, or digitally, as shown in FIG. 16, though other implementations are possible without departing from the scope of this disclosure) that changes based on the number of detected early events and late events, as shown by the binner output of FIG. 2B. As depicted in FIGS. 3A and 3B as well as FIG. 4, the binner may generate a bin boundary that eventually converges at or near the median of the return events or at another target k-quantile of the distribution of return events. The accuracy of identifying the actual median of the return events may be influenced by the signal intensity and the amount of background light in the scene, as shown by FIGS. 5A-5D and FIGS. 6A-B.

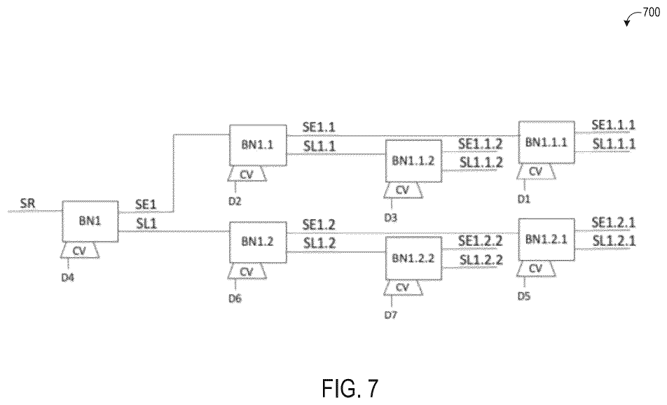

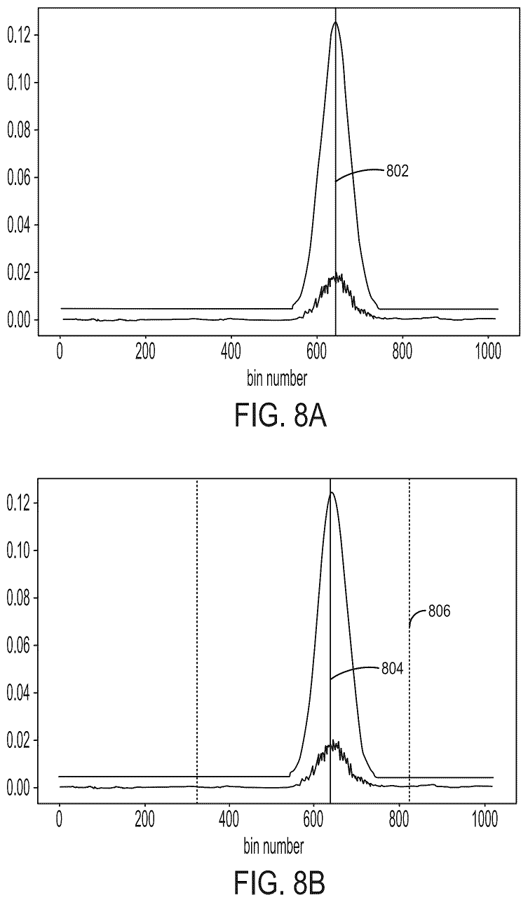

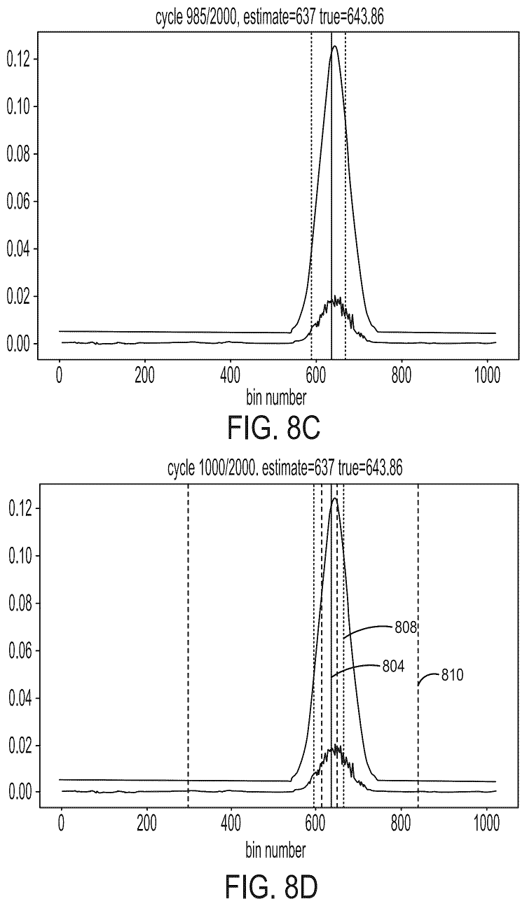

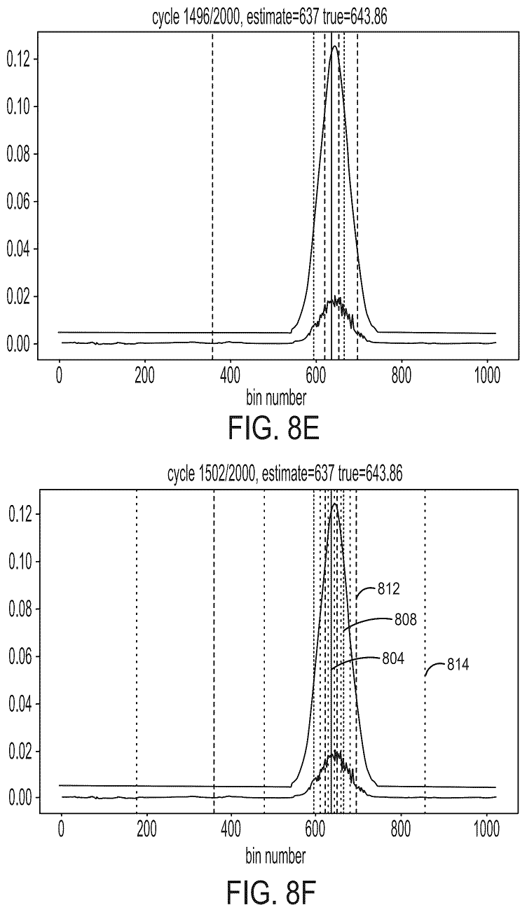

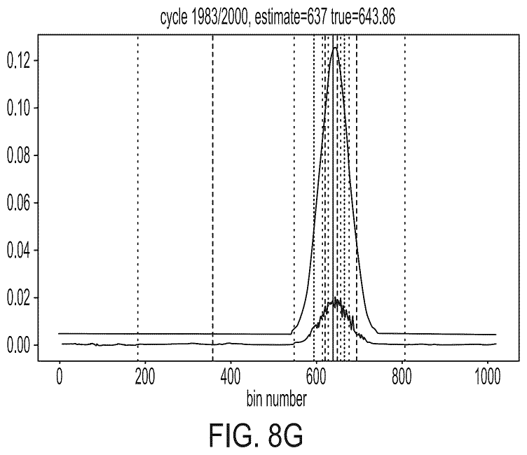

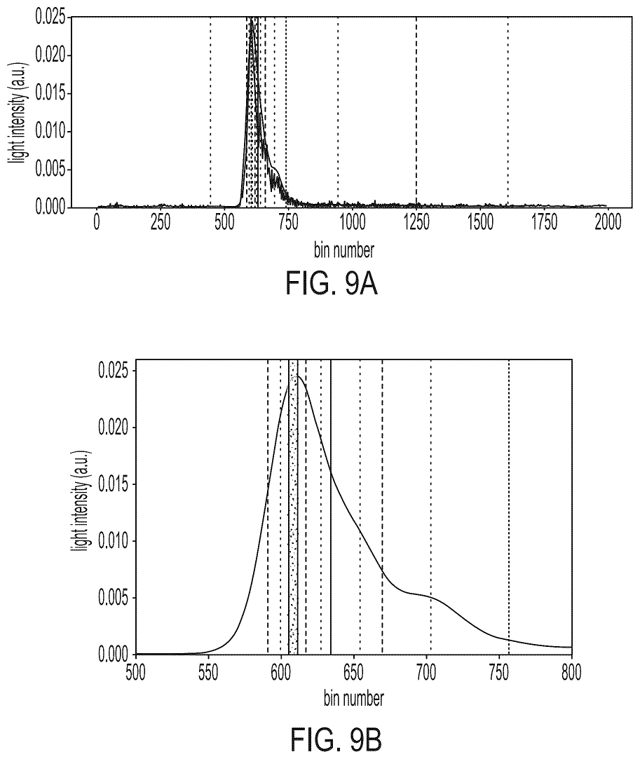

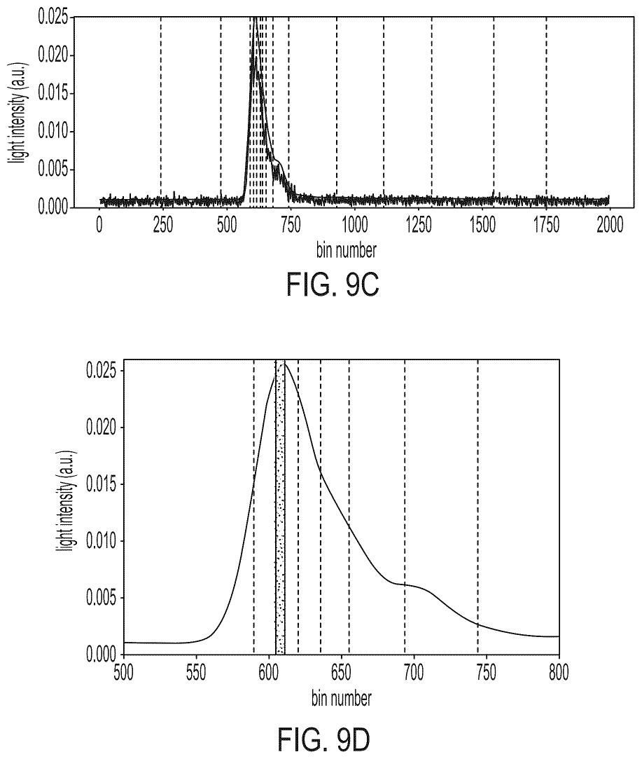

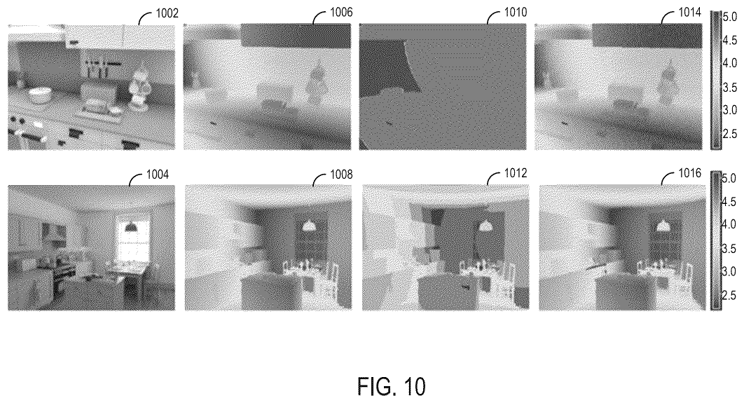

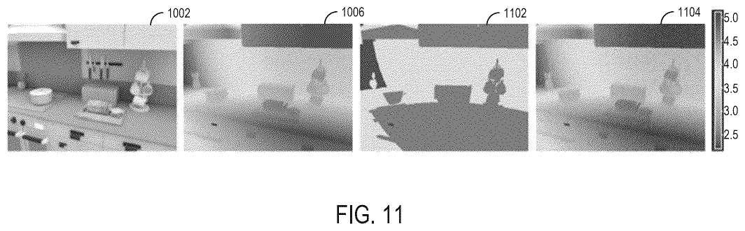

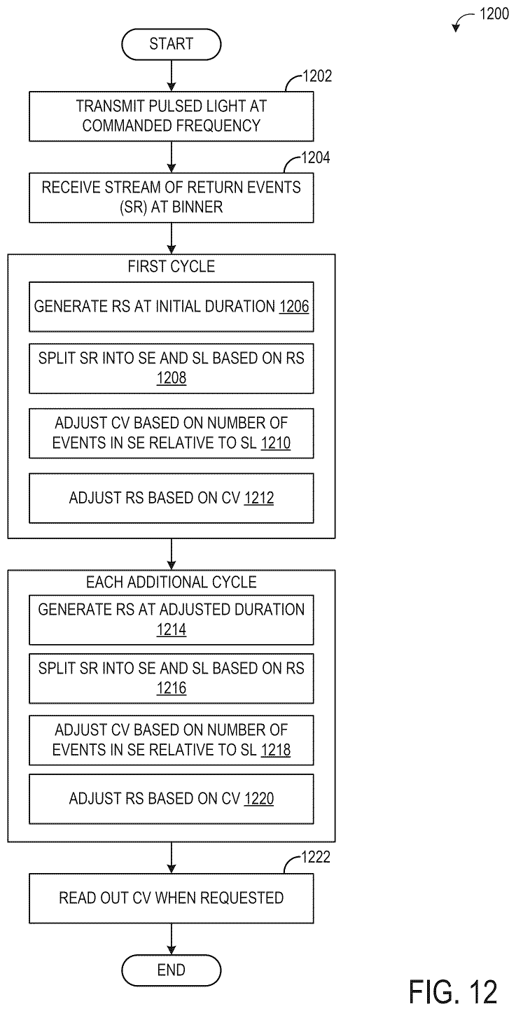

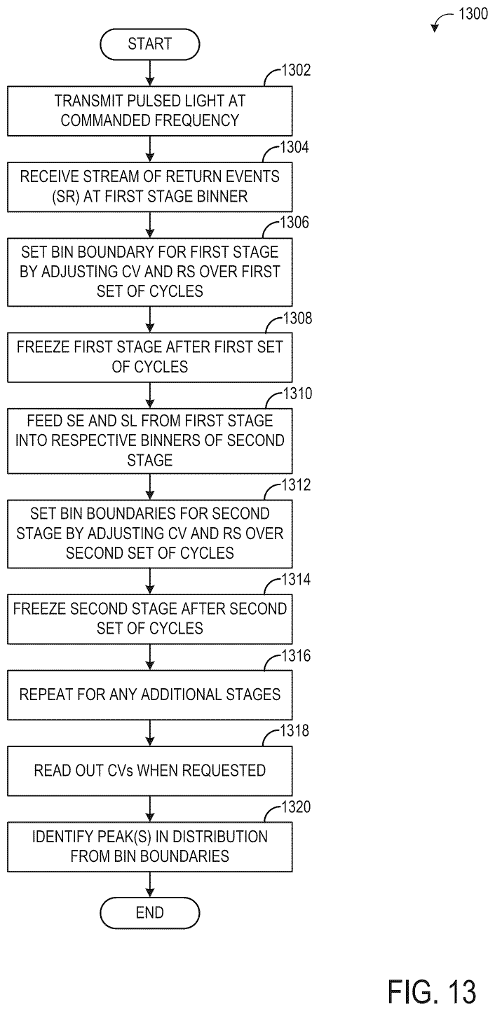

A binner may have a single stage, such the binner of FIG. 2A, or multiple binners may be present in multiple stages to realize an equi-depth histogrammer (EDH), such as shown by the multi-stage histogrammer of FIG. 7. The multi-stage histogrammer can identify/converge on multiple bin boundaries depending on the number of stages of the multi-stage histogrammer, such as 7 or 15 bin boundaries (and hence 8 or 16 bins). As appreciated by FIGS. 8A-8G, which show convergence of 15 bin boundaries across a plurality of cycles of a run, the bin boundaries may be concentrated around the true peak location of the transient distribution. Further, the multiple bins may allow background light to be “absorbed” by a portion of the bins, leaving the remaining bins to cluster around features of the distribution, such as the peak(s) of the distribution. Such histogrammers may be influenced less by background light, as shown by FIGS. 9A and 9B. Example distance maps generated using 8-bin and 16-bin, respectively, equi-width and equi-depth histograms are shown in FIGS. 10 and 11. Thus, a binner may be used to identify a bin boundary in a transient distribution (e.g., of photon events), according to the example method of FIG. 12, and a histogrammer may be used to identify a plurality of bin boundaries in a transient distribution, according to the example method of FIG. 13.

Turning now to the figures, FIG. 1 schematically shows an example imaging environment 100 for imaging a scene with a single-photon-sensing 3D imaging system according to an embodiment. The environment 100 includes a light source 102, an object 104, and a detector 106. The environment further includes a computing device 110. While the light source 102 and the detector 106 are shown as separate devices in FIG. 1, it is to be appreciated that the light source 102 and the detector 106 may be integrated in a single device (such as integrated within the computing device 110). The light source 102 and detector 106 may form a single-photon-sensing 3D camera (SPC) that captures distance (e.g., depth) information using the time-of-flight principle-akin to echolocation, but with light instead of sound. Consider a single scene point where distance needs to be estimated as shown in FIG. 1. The light source 102 (which may be a laser) illuminates a scene point (which may be part of object 104) with a short light pulse (e.g., the transmitted pulse shown in FIG. 1). Detector 106 may include an array of detector elements, with each detector element configured to (separately) detect photons. In some examples, each detector element may be a diode, such as a single-photon avalanche diode or an avalanche photodiode. As used herein, the detector elements may be referred to as pixels and thus the detector 106 may include a plurality of pixels. A pixel of detector 106 may capture a stream of return events (e.g., the return photon events of FIG. 1) as photons arrive at different time delays with respect to the time the original light pulse was transmitted. (The detector 106 in general captures more than one return event in response to each laser pulse sent into the scene.) Moreover, this return stream may also contain spurious photon events not due to the light pulse (signal), but rather to ambient background light and other sources of noise in the image sensing hardware. Traditionally, a histogram is constructed by accumulating photon counts at different delays over many light (e.g., laser) cycles. The “arg max” peak location of this histogram gives an estimate of the true distance of the scene point (relying on the simple relationship that the speed of light multiplied by the time delay is equal to twice the distance to the scene point). As will be explained in more detail below, power consumption, memory requirements, and processing power needed to determine object distances may be reduced if the true distance of the scene point is estimated using an equi-depth histogram instead.

As mentioned above, the light source 102 may be a laser or another suitable light source capable of transmitting light in pulses at a frequency dictated by a clock 108. The detector 106 may be a single-photon avalanche diode (SPAD) sensor with single-photon sampling, an avalanche photodiode (APD) sensor, or another suitable image sensor capable of capturing single photons. The detector 106 may receive pulse frequency information from the clock 108 (e.g., indicating the start and end of each pulse of the light source 102).

The computing device 110 (which may include the light source 102 and/or of the detector 106 in some examples) may be a smartphone camera, a light detection and ranging (LiDAR) sensor (e.g., for autonomous robotics), a camera for scientific imaging, a virtual reality device, an augmented reality device, a desktop computer, a laptop, a mobile device (e.g., smartphone or tablet), or another suitable device.

Due to their compatibility with CMOS fabrication technology, there is increasing availability of high (kilo-to-megapixel) resolution arrays of single-photon detecting (e.g., SPAD) pixels with additional data processing embedded in the hardware chip that includes the single-photon detecting pixels. Unfortunately, the high sensitivity and high speed is a double-edged sword: the amount of raw data generated by these detectors is orders of magnitude higher than can be reasonably processed or transferred in real-time. This aspect limits their applicability in many real-world applications, especially those that are power and bandwidth constrained.

Accordingly, and as explained in more detail below, embodiments are provided herein that offer a different approach for direct time-of-flight imaging that is compatible with a variety of detector and illumination schemes. Capturing and transferring the entire received waveform (either through single-photon sampling with a SPAD pixel, or fast analog-to-digital conversion of an APD) is resource hungry. Instead of attempting to capture the complete waveform in the digital domain (which often consumes a large fraction of the total power), the embodiments disclosed herein perform as much of the processing as possible in the analog domain. To this end, aspects in the field of race logic are applied, where information is encoded not in the voltage levels of signals but in the precise arrival times of the signals. This approach is naturally suited to single-photon time-of-flight 3D sensing because the arrival times of the photon-return events carry useful scene information (scene distances and reflectivity). Additionally, the embodiments disclosed herein utilize equi-depth (ED) histograms to represent the transient distribution of photon return events, rather than the equi-width (EW) histograms shown in FIG. 11 that other methods employ. The power and bandwidth limitation of single-photon cameras severely limits wider applicability of high resolution SPC arrays. Creating the full EW histogram on-sensor is infeasible due to severe memory constraints, while moving photon timestamp data off-sensor is undesirable because it introduces latency and consumes power. The ED histograms and use of photon-arrival times as described herein address these issues, as they reduce or eliminate the need for large storage on the sensor and utilize very little power by transferring very little data off-sensor.

As mentioned above, the detector 106 (and at least in some embodiments, also the light source 102) may be integrated in or operably coupled to the computing device 110. While not shown in FIG. 1, it is to be appreciated that computing device 110 may include a logic subsystem such as a processor and a data-holding subsystem such as a memory. The computing device 110 may optionally include a display subsystem, a communication subsystem, a user interface subsystem, and other components. The processor comprises one or more physical devices configured to execute one or more instructions. For example, the processor may execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The processor may thus include one or more processors configured to execute software instructions. Additionally or alternatively, the processor may comprise one or more hardware or firmware logic machines configured to execute hardware or firmware instructions. As illustrative and non-limiting examples, the processor may comprise one or more central processing units (CPU), graphics processing units (GPUs), field-programmable gate arrays (FPGAs), application-specific integrated circuits (ASICs), and so on. The processor may be single or multi-core, and the programs executed thereon may be configured for parallel or distributed processing. The processor may optionally include individual components that are distributed throughout two or more devices, which may be remotely located and/or configured for coordinated processing. Such devices may be connected via a network.

The memory of the computing device 110 may comprise one or more physical, non-transitory devices configured to hold data and/or instructions executable by the processor to implement the methods and processes described herein. When such methods and processes are implemented, the state of the memory may be transformed (for example, to hold different data).

The memory may include removable media and/or built-in devices. The memory may include optical memory (for example, CD, DVD, HD-DVD, Blu-Ray Disc, and so on), and/or magnetic memory devices (for example, hard drive disk, floppy disk drive, tape drive, MRAM, and so on), and the like. The memory may include devices with one or more of the following characteristics: volatile, non-volatile, dynamic, static, read/write, read-only, random access, sequential access, location addressable, file addressable, and content addressable. In some embodiments, the processor and the memory may be integrated into one or more common devices, such as an application-specific integrated circuit or a system on a chip.

The computing device 110 may be communicatively coupled to a display device. As illustrative and non-limiting examples, the display device may display an image captured by detector 106, the display device may display an image that is sized/positioned based on a distance map determined from the output of the detector 106, etc. The display device may include one or more display devices utilizing virtually any type of display technology such as, but not limited to, cathode ray tube (CRT), liquid crystal display (LCD), light-emitting diode (LED), organic LED (OLED), electroluminescent display (ELD), active-matrix OLED (AMOLED), quantum dot (QD) displays, and so on. As another example, the display device may comprise a display projector device such as a digital light processing (DLP) projector, a liquid-crystal-on-silicon (LCoS) projector, a laser projector, an LED projector, and so on. As yet another example, the display device may comprise an augmented reality (AR) display system, a virtual reality (VR) display system, or a mixed reality (MR) display system.

FIG. 2A shows a circuit diagram for a single-stage binner and FIG. 2B shows an example outcome of the binner, according to an embodiment of the disclosure. The term binner, as used herein, refers to a circuit that, over the course of many laser pulses, generates a control value that adaptively converges to the k-quantile of a transient distribution. In particular, FIG. 2A includes a circuit diagram of a binner 200 configured to adaptively find a bin boundary in a range of a transient distribution (e.g., of photon return events), using the proportion of return events arriving earlier and later than the current boundary to adjust that boundary. The range over which return-delay information is accumulated is referred to herein as a window, with a scale denominated in minimum discernible units. For the examples presented herein, a window may be 1024 units long, which is discretized into 128-picosecond steps. This corresponds to a bin resolution of approximately 3 cm. However, other window lengths (e.g., 2000-unit windows, windows between 1024 and 2000 units, or windows over 2000 units) and step lengths are possible without departing from the scope of this disclosure. In some aspects, the maximum window length may be limited by the cycle time of the laser pulse, which in turn decides the maximum distance range of the 3D camera. The aggregated photon-return-event information over a window may be referred to as the transient distribution.

In its simplest form, the binner 200 adjusts the bin boundary so that equal portions of return events fall on each side of the bin boundary, such that the binner seeks the median. A key aspect of the binner 200 is that at least the early stages of processing of the return events can be implemented with low-power race logic. The current value of the bin boundary may be represented via a reference signal that starts high at the beginning of each cycle, and drops low at the point in the window corresponding to the delay that the bin boundary represents. By leaving return events as delays, the return events can be classified relative to the reference signal with very few device switches, rather than converting the return events to timestamps. The early and late event streams may be used to adjust the duration of the reference signal, hence the current location of the bin boundary.

The binner 200 includes a reference signal generator 202 that outputs a reference signal RS having a waveform that starts high at the beginning of each cycle (when the laser pulse is sent), and drops low after a delay that corresponds to a bin-boundary position. The binner 200 combines the RS with a stream of return events (SR) to yield two output streams. The SR may be voltage pulses generated by a pixel of the detector, each indicating that a photon has impinged on the pixel of the detector. The two output streams include an early stream (SE) of events that arrive earlier than the current boundary, and a late stream (SL) of events that are later than the current boundary. In addition to possibly feeding the SE and SL streams on to additional binner stages (which is explained in more detail below with respect to FIG. 7), the binner 200 uses the SE and SL streams to adjust a control value (CV) 204 that dictates the length of the high portion of the reference signal RS. Events in SE decrease CV, while those in SL increase CV. The reference signal generator 202 may be a monostable multi-vibrator (e.g., a one-shot circuit) with a waveform (e.g., a duration of the high portion of the waveform) governed by the control value. Because the CV controls/adjusts the RS, the CV may also be referred to herein as a reference signal modulator. The binner 200 further includes two AND gates, AND gate G1 206 and AND gate G2 208 (where G2 has one input inverted), which generate streams SE and SL from input stream SR. In addition, the binner 200 provides for readout of the current control value at any point.

The control value CV may be an integer in a suitable range determined based on the configuration of the single-photon camera (e.g., light source strength, pulse frequency). For example, the CV may be an integer in the range 1 . . . 1024, where each number corresponds to a particular number of time units of delay. As a specific and non-limiting example, each time unit may be 128 picoseconds, which represents a distance of 1.9 cm or 3.8 cm round trip. The binner may be configured to seek a bin boundary at the 50th percentile (that is, the median) of the transient distribution, and thus the CV may be initialized to 512. Return events in SE and SL may decrement and increment CV by 1 unit, respectively.

The binner 200 may be implemented with a field-programmable gate array (FPGA) or the binner may be implemented in-pixel using an application specific integrated circuit (ASIC). The ASIC may have a mixed-signal configuration where some parts are implemented in the analog domain and others in the digital domain after A-to-D conversion. Additional details of the binner configuration are presented below with respect to FIGS. 15 and 16. The binner 200 may be configured to seek the median (or other k-quantile, such as 75%) of the transient distribution of return events detected by a single pixel. In such examples, each pixel of the detector may be coupled to a respective binner. In other examples, the binner 200 may be couplable to more than one pixel and may sequentially determine a bin boundary of the transient distribution of return events of each pixel to which the binner is configured to couple.

FIG. 2B schematically shows example output 250 from the binner 200 for one window of return events (e.g., over a window commencing at the window start and ending at the window end), obtained over the course of one cycle (e.g., in response to one outgoing light pulse). The return events in the stream of return events (SR) over the window are shown along the top plot, with each peak/square wave indicating a detected photon. The reference signal (RS) over the window is shown along the first plot from the top. The RS has a waveform with a first portion that has a high value and a second portion that has a low value. The first portion has a relatively long duration in this example, e.g., more than 50% of the length of the window, and switches to the second portion at the dashed vertical line. The SE events over the window are shown in the second from the top plot, while the SL events over the window are shown in the bottom plot.

In the window shown, six return events are detected. The first four return events are classified as early events, due to each return event having a delay time (e.g., from the light pulse until the photon is detected) that is smaller than the time specified by the reference signal (e.g., the events are detected while the RS is high). At the time shown by the dashed line, the RS switches to the low value, and the subsequent two return events are classified as late events (e.g., having a delay time that is greater than the time specified by the reference signal). In one example, events in the SE decrement the control value by one unit and events in SL increment the control value by one unit, and thus at the end of the window, the control value may be decreased by two units. However, the binner may be configured so that events in SE decrement and/or events in SL increment the control value by a different amount.

The binner runs for multiple cycles (e.g., multiple light pulses). If, at a given cycle, the current bin boundary (as represented by the reference signal) is below the median of the distribution, then more return events in SL are expected than in SE, making for more increments of CV, thus driving the bin boundary towards the median. For example, suppose the true median is 820 and CV is currently at 612. On a given cycle, three return events may be classified as SE and five return events may be classified as SL, thus moving CV to 614. Over a sufficiently long series of cycles—which is termed a run—the bin boundary should closely approximate the true median of the transient distribution and the control value CV may be read out for further image processing. Thus, the binner disclosed herein does not store the history of photon counts across cycles to form a histogram. Rather, the binner updates its CV immediately and locally in each laser cycle based only on photons received in that cycle. Each pixel need only maintain its CV, providing a large reduction in data requirements.

The movement of the bin boundary is probabilistic. While movement in the desired direction on any particular cycle is not guaranteed, on average there should be convergence towards the median. FIGS. 3A and 3B show movement of the boundary of a binner over multiple cycles in a run. FIG. 3A includes a first plot 300 showing a bin boundary output by a binner (such as the binner 200) at a relatively early cycle (specifically, at cycle 160 out of 5000 cycles) in a run. The transient distribution is a Gaussian pulse with a constant offset, as shown by curve 302, and has a peak at approximately 300. The x-axis of the first plot 300 shows window units ranging from 0-1023, which corresponds to the range of CVs described above (e.g., each unit of CV may be equal to 128 picoseconds). The bin boundary as reached by the binner at cycle 160 is shown by line 304, and is at approximately 450.

As the 5000 cycles are run, the bin boundary may settle closer to the actual peak. FIG. 3B is a second plot 350 showing a bin boundary reached by the binner at a relatively late cycle (specifically, at cycle 4800 out of 5000 cycles) in the run. The bin boundary output at cycle 4800, shown by line 352, is near the peak (e.g., at 330, with the peak at 300). The bin boundary may settle slightly off the peak because of bias from background light.

FIG. 4 shows a plot 400 of mean absolute deviation from the true peak location as a function of cycle number for a Monte Carlo simulation of a single binner (e.g., the binner 200) simulated 100 times over 5000 laser cycles. At each cycle, the binner's estimate of the bin boundary incremented or decremented with step sizes of +/−1. Thus, the plot 400 shows a convergence pattern over 5000 cycles for a strong signal pulse (a strength of 0.5, represented by Nsig=0.5, which controls the expected number of return events in a cycle arising from an outgoing laser pulse) with low ambient light (Nbkg=0.005, which is the background that is expressed in the expected number of events per window unit) over 100 runs selected from the parameter space, where each run uses a different true peak location over a window of 1024 time units. Once the CV nears the median, it will “wander” in the vicinity of the median. Thus, the binner can return slightly different values for the bin boundary depending on when the control value is read out, which can limit its accuracy, though the accuracy improves when multiple read-outs are combined.

The plot 400 of FIG. 4 demonstrates that a binner may take 1000s of cycles to converge at the median/true peak location, at least in some cases. Note that each cycle is on the order of nano-to-microseconds, so the total elapsed time is at most a few milliseconds, which may seem insignificant. However, in terms of energy consumption, speeding convergence could have significant benefit, as long as it does not entail extensive processing on the detector.

In one aspect, convergence speeds may be increased by using a better starting estimate for the bin boundary. If multiple runs are performed with a slowly changing scene, the median value from the previous run may be used as the initial control value/bin boundary. If readings for multiple points in a scene are obtained using one pixel via scanning (or using the same binner sequentially for different pixels in a neighborhood), the estimated median of an adjacent pixel may be used as an initial value. In another aspect, convergence speeds may be increased by using a large increment/decrement step size of the control value early in a run, and reducing the step size as the run progresses. However, with the coarser step sizes, the CV may not reach the exact median. If the median (or near the median) is reached quickly, the CV will oscillate around the median farther, until the step size gets smaller. Thus, using a variable CV step size may speed convergence.

An adaptive method for speeding convergence may be applied, in some examples. In the adaptive method, instead of a fixed adjustment to the CV per cycle, the CV may be adjusted based on the number of return events. Intuitively, when the CV is far from the median, many more events will fall on the median side of the current bin boundary rather than the other side. Hence, at the beginning of a run, there will be more movement per cycle, but that movement will reduce as the boundary nears the median. Note that essentially the same effect is observed by adjusting the CV once per cycle by a step equal to the difference between the early and late return events for the cycle.

A binner may need different numbers of cycles to converge under different conditions. Thus, it may be possible to terminate a run early if the bin boundary has converged. Trying to determine convergence on a per-pixel basis may have marginal benefit, as it may demand significant extra circuitry and the laser to keep pulsing until all pixels have converged. However, in some examples, overall convergence may be determined by reading out (a subset of) the pixel control values periodically, and checking if there is a large enough change in any of the control values (by comparing with some pre-determined threshold). However, read out from the detector is one of the more energy-intensive activities in binner operation. For example, readout may be energy intensive because moving data consumes energy, particularly for detectors that include millions of pixels, so such an approach may not result in an overall net power savings.

In other aspects convergence time may be predicted based on current conditions mainly signal strength (e.g. of the light source) and background level. Background level is essentially ambient light, which may be measured with a co-located photodetector, or by simply measuring the total number of return events recorded by the pixels of the detector over a fixed exposure time with the laser turned off. Signal strength may be determined by running the binners for a selection of pixels for a short period (e.g., 100 cycles) and seeing how much shift is observed in the boundaries in that time. In some aspects, the method accounts for the variations in reflectivity across a scene, which affects the number of return events. A rough estimate of reflectivity may also be inferred from images captured by a co-located RGB camera.

As described previously, in some examples, each return event in SE or SL adjusts the CV by one unit. However, other options for adjusting the CV are possible without departing from the scope of this disclosure. For example, the CV may be adjusted once per cycle, based on the relative numbers of return pulses on SE and SL. In some aspects, determining the relative number of pulses on each output stream does not necessarily mean counting the number of pulses. Instead, the pulses may be used to charge two capacitors, whose differential (e.g., as determined by an op-amp) indicates the direction of adjustment, or the SL and SE streams could directly feed into an op-amp configured as an integrator. Additionally, the step size for adjustment need not be one unit. In particular, near the beginning of a run, a large step size may be advantageous, and the step size may decrease over time in order to more accurately seek the median.

In the initial description provided above, the adjustments corresponding to SE and SL are equal, thus driving the binner boundary to the median. However, by using different values for decrement and increment, a different percentile for the bin boundary may be targeted. For example, with a decrement to increment step-size ratio of 3:1, the binner boundary tends towards the 25^{th} percentile. That is, a decrement of 1 and an increment of ⅓ may be applied if the control values support fractional amounts. If the control values do not support fractional adjustments, or if larger step sizes are desired to speed up convergence, other combinations of decrement/increment step sizes may be used, such as 3 and 1 or 6 and 2, both of which would converge towards the 25^{th} percentile. Yet another alternative is to make equal size adjustments, selecting all of the decrements but selecting only a third of the increments, deterministically or probabilistically.

The term “binner” as used previously by itself may refer to a median-finding binner, and the term “proportional binner” may be used to describe a binner that targets a particular k-quantile or percentile of the return distribution. Another variation is to initialize the CV to something other than the midpoint of the window. That capability may be useful in EDHs built from binners, which are described in more detail below.

Another key facet of binner design space is the representation of the control value, and how the binner generates the reference signal from the control value. The main choices are to represent the CV as a digital number or as an analog quantity, such as charge or voltage (an example of which is shown in FIG. 15). The digital case (an example of which is shown in FIG. 16) demands circuitry to generate the reference signal of length proportional to the CV, which likely demands a significant number of circuit elements, which draw power. The advantage of digital representation is that readout and initialization of the CV are straightforward. An analog representation of the CV likely consumes less power (but might be trickier to initialize). However, an analog CV may demand conversion to digital form at some point for further image processing. Even so, that conversion could happen in a (partially) sequential manner at the end of a run. For an array of pixels, charges or voltages from the various CVs in a row of pixels may be shifted to one edge where there is an A/D converter per row. Another approach to the CV readout is to actually route the reference signal of a binner to a time-to-digital converter (TDC). Scaling of increment and decrement values-either for variable step sizes or proportional binning—might be simpler with an analog representation of the CV, as the step size or proportion can itself be an analog value.

FIGS. 5A-5D show the effect of different factors on convergence. Specifically, FIGS. 5A-5D show the results of three different stepping schemes: a naive method that takes small constant steps of size 1 (shown as the solid line curves in the plots of FIGS. 5A-5D and labeled as “step size 1”), a weighted step method that takes steps equal to the difference in the number of return events in a cycle (shown as the dashed line curves in the plots in FIGS. 5A-5D and labeled as “lr dif step”), and finally an ad hoc variable step-size schedule that takes large steps initially and then reduces the step size for subsequent laser pulses (shown as the dotted line curves in the plots of FIGS. 5A-5D and labeled as “steps 8,4,2,1”). In the examples shown in FIGS. 5A-5D, a variable step-size schedule gives the best rate of convergence. Plot 502 of FIG. 5A shows that in a high-signal, low-background imaging regime, the variable step-size method quickly converges to the median. Plot 504 of FIG. 5B shows that in a high-signal, high-background regime, quick convergence is observed, but the final estimate is still quite noisy. Plot 506 of FIG. 5C shows that in a low-signal, low-background regime, the convergence takes longer than with a high-strength signal, but a variable step-size schedule achieves 10× improvement over the other schemes. Plot 508 of FIG. 5D shows that in the low-signal, high-background regime, the final estimates show large excursions from the true median location. These plots also suggest that there is an advantage in averaging multiple measurements post-convergence, especially in high-background situations.

The plots of FIGS. 5A-5D were generated by performing a Monte Carlo simulation study of a single binner with three different stepping schemes over different operating conditions (low and high signal power in the presence of low and high background light levels): Constant small step size of 1; Photon-number-weighted step size; and 4-stage coarse-to-fine step-size schedule (8→4→2→1), each for one-quarter of the total cycles.

The coarse-to-fine stepping scheme provides the fastest convergence under all operating conditions. It is faster than the constant step size method by a factor of at least 10× in most cases. In the high-signal-strength regime, the scheme settles to an optimum quite rapidly and then it is limited by the step size. This effect is visible in plots 502 and 506 of FIGS. 5A and 5C, respectively, where the dotted line plot converges quite rapidly at first but then it makes further improvement with a finer step size as seen from the discrete jumps at 1250 and 2500 cycles. The results suggest that signal-dependent step-size optimizations can further speed up convergence. In high-strength regimes, it helps to rapidly decay the step sizes to the finest level, whereas in low-strength regimes, larger steps should persist for larger fractions of the total exposure time budget. In practice, a heuristic step-size schedule informed by this simulation study may be used.

In some examples, an initial “calibration” scan may be performed to assess Signal-to-Background Ratio (SBR) conditions at different scene points (where SBR is the ratio of the expected number of signal photons to background photons, aggregated over the entire window range). High-SBR pixels can rapidly decay to small step sizes, while low-SBR pixels use large step sizes for longer durations. The difference between the constant-small-step-size and weighted schemes is less marked, though the weighted scheme (dashed lines) does converge faster than the constant-size scheme (solid lines). In FIGS. 5A-5D, only a slight advantage is seen for the low-strength regimes where the weighted scheme has a similar convergence rate as the constant-step scheme. This is because in the low signal and background regimes, very few photon events are generated in each cycle, so there are very few cases where the boundary moves more than one unit per cycle. In the high-strength regime, the weighted scheme does noticeably better than the constant-step scheme. However, with a strong signal, convergence is fast with all schemes.

Low power and fast convergence are important, but it is also desirable for the binner to converge to the right place (the true median). FIGS. 6A and 6B show the bin boundary of a binner after 1000 cycles for the same synthetic peak (Nsig=1.0, pulse width 5 ns), but with low background level (Nbkg=0.0001, FIG. 6A) and high background level (Nbkg=0.005, FIG. 6B). In the high-background case shown in FIG. 6B, the final boundary is farther away from the peak. The reason for the shift may be that the binner is accurately reflecting the median of the full transient distribution, consisting of the synthetic peak plus the background. The median of the background, if it is truly uniform, will be the midpoint of the window. Thus, the midpoint of the combined distribution will be “pulled” toward the center of the range by the background events—the stronger the background, the larger the bias towards the midpoint.

In some aspects, background bias may be compensated for by measuring the background level without the outgoing laser pulses. If there are sufficient bins in an equi-depth histogram, as produced by an equi-depth histogrammer described in more detail below, the multiple bins may “absorb” background light, leaving the structure around the peaks unshifted. It may be different bins that actually capture the peaks in the low- and high-background cases, but locally around the peaks relative bin widths are quite similar.

A single binner finds a single boundary, hence a single binner produces only a two-bin ED histogram. A single binner might be effective for locating a single peak; however, there are issues with bias from background light levels as discussed above. To get an EDH with more than two bins, multiple binners may be combined.

One approach to obtain an EDH with B bins is to use an array of B−1 proportional binners, each targeting a different percentile. For example, for 10 bins, nine proportional binners may be used, set at the 10th, 20th, . . . , 90th percentiles. In this approach, all of the binners in the array of binners may receive photon return events from a detector/pixel directly. Alternatively, if an adjustable proportional binner is used, nine runs may be performed with the adjustable proportional binner sequentially set at the different percentile values. In this way, a single proportional binner may be run for multiple runs with the control value adjusted differently in different runs (e.g., targeting different percentiles) to produce different percentiles that correspond to bin boundaries in a histogram. The latter approach may consume more energy from the laser but may use a simpler pixel circuit. Because the level of gradations that may be obtained with proportional binners may be limited, in other aspects median binners may be combined in a recursive style, providing ED histograms with a power-of-two number of bins. In this arrangement, each binner BN at stage i feeds two binners, BN1 and BN2 at stage i+1 with its output streams SE and SL, respectively.

For illustration, FIG. 7 shows a 3-stage EDH 700 that produces eight bins. In FIG. 7, the cycle-start lines to the binners are omitted, to keep the figure less cluttered. Each binner may be configured similarly to binner 200 of FIG. 2A. EDH 700 includes a first stage comprising a first binner BN1 that may receive a stream of return events (SR) and split the stream into an early stream (SE1) and a late stream (SL1) according to a control value, as explained previously. EDH 700 includes a second stage comprising two binners (BN1.1 and BN1.2), where the early stream SE1 feeds into BN1.1 while the late stream SL1 feeds into BN1.2. BN1.1 may split the SE1 into two streams based on a corresponding CV, an early stream SE1.1 and a late stream SL1.1. Likewise, BN1.2 may split the SL1 into two streams (SE1.2 and SL1.2) based on a corresponding CV. EDH 700 further includes a third stage comprising four binners (BN1.1.1, BN1.1.2, BN1.2.1, and BN1.2.2). Each stream may feed into a respective subsequent binner (e.g., SE1.1 may feed into BN1.1.1 and SL1.1 may feed into BN1.1.2, and each of SE1.2 and SL1.2 may feed into BN1.2.1 and BN1.2.2, respectively). The seven bin boundaries are read out from the respective CVs to produce D1, D2, . . . , D7, corresponding to an in-order traversal of the tree of binners. FIG. 7 shows a three stage EDH that generates 8 bins. Adding a fourth stage comprising eight additional binners (e.g., such that SE1.1.1, SL1.1.1, SE1.1.2, SL1.1.2, SE1.2.1, SL1.2.1, SE1.2.2, and SL1.2.2 each feed into a respective additional binner) would result in identification of 16 bins.

FIGS. 8A-8G show the movement of the bin boundaries using a four-stage (16-bin) EDH. Each stage is given 500 cycles to converge. The boundaries are then “frozen” at each stage and the binners are launched at the next stage. The line patterns indicate the boundaries at different stages: solid=1st, dense dots=2nd, dashes=3rd, spare dots=4th. The transient distribution in this case is a Gaussian signal pulse with a low background level.

Specifically, FIG. 8A shows the bin boundary (solid line 802) determined by the first stage (e.g., the first binner) of the EDH, at cycle 483 of the run. The bin boundary is near the true median (the bin boundary is 642 while the true median is 643.86). At cycle 500, the first stage is frozen (such that the bin boundary determined by the first stage is identified and then does not change) and the second stage is launched, as shown in FIG. 8B (the solid line 804 shows the first-stage bin boundary while the dense dotted lines, such as line 806, show the initial locations of the bin boundaries of the second stage). FIG. 8C shows the bin boundaries of the second stage at cycle 985, which is near cycle 1000 (where the second stage is frozen) and thus the bin boundaries shown in FIG. 8C are approximately the identified bin boundaries of the first and second stages.

At cycle 1000, the second stage is frozen (such that the bin boundaries determined by the second stage are identified and then do not change) and the third stage is launched, as shown in FIG. 8D (the solid line 804 shows the first-stage bin boundary, the densely dotted lines, such as line 808, show the final locations of the bin boundaries of the second stage, and the dashed lines, such as line 810, show the initial locations of the bin boundaries of the third stage). FIG. 8E shows the bin boundaries of the third stage at cycle 1496, which is near cycle 1500 (where the third stage is frozen) and thus the bin boundaries shown in FIG. 8E are approximately the identified bin boundaries of the first, second, and third stages.

At cycle 1500, the third stage is frozen (such that the bin boundaries determined by the third stage are identified and then do not change) and the fourth stage is launched, as shown in FIG. 8F (the solid line 804 shows the first bin boundary, the dense dotted lines, such as line 808, show the final locations of the bin boundaries of the second stage, the dashed lines, such as line 812, show the final locations of the bin boundaries of the third stage, and the sparse dotted lines, such as line 814, show the initial locations of the bin boundaries of the fourth stage). FIG. 8G shows the bin boundaries at cycle 1983, which is near the end of the run and thus the bin boundaries shown in FIG. 8G are approximately the identified bin boundaries of the first, second, third, and fourth stages. Thus, the signal strength is high enough that the EDH uses only 4 of the 16 bins for absorbing background events, while the remaining 12 EDH bins settle around the true peak location.

In the operation of a multi-stage EDH, convergence of later stages is affected by earlier stages. First off, later stages get fewer return events than earlier stages. Consider binners BN1 and BN1.1 in FIG. 7. At the point BN1 has converged to the median for the input stream SR, binner BN1.1 will only receive half as many return events on SE1. Thus, binner BN1.1 will tend to converge more slowly, however binner initialization (see below) and the smaller window ranges on later stage binners compensate for the reduced number of events. Also, if the boundary of BN1 is not frozen before starting the next stage (or if all binners are launched at once), the subrange of the transient distribution that BN1.1 handles shifts, and hence the median for BN1.1 is a moving target.

In general, the more stages in a multi-stage EDH, the more cycles before the EDH converges. In some aspects this effect may be ameliorated by the initialization of the boundaries of the different binners. For example, random events may be fed into SR before commencing a run, which will tend to drive the bin boundaries D1, D2, . . . , D7 to equally spaced positions in the window range. (However, some boundaries may still need to move over most of the range of the transient distribution if the transient distribution contains a strong peak near the beginning or end of the window.) In additional aspects, the stages may be frozen sequentially, starting at binner BN1 and working down the tree. Thus the distribution subrange that a binner handles is fixed after some point in the run.

In other aspects, binners at stage i+1 are only launched after the binners are frozen at stage i. To maximally benefit from this approach, the bin boundaries from stage i may be used to initialize those at stage i+1. For example, if binner BN1 has boundary value v when frozen, BN1.1 and BN1.2 may be initialized to v/2 and (w+v)/2, respectively, where w is the window size. Later-stage binners may be initialized to the midpoints of their ranges when they are launched. (FIGS. 8A-8G depict this strategy.) While binners may be initialized by adding circuitry to set control values, in other aspects uniformly distributed events may be fed into the RS, which will drive boundaries of unfrozen binners to the midpoint of their ranges. (Even without initialization, sequential activation of binners in an EDH can save power, if not convergence time.)

Additionally or alternatively, bin boundaries from one run of an EDH may serve as the starting values for a subsequent run. Such a situation arises when multiple runs are tracking a scene over time. The ED histograms from consecutive scenes are likely to have similar bin boundaries, and hence the time for the EDH to adjust from one scene to the next should be short.

Another case where boundaries from runs are likely to be similar is adjacent pixels in an array. In some aspects, the boundaries for pixel P may serve as a starting point for adjacent pixel Q. Taking advantage of this correlation means sequential runs for P and Q. However, the run for Q can be shorter. P and Q may then use the same EDH circuit, which avoids the problem of transferring boundary values from one EDH to another. More generally, pixels may be grouped into small regions (for example, 2×2) that use the same EDH, with a “full” run for one pixel in the region, followed by shorter runs on the remaining pixels in the region that each take advantage of the bin boundaries of the previous run. Using a single EDH for a group of pixels will also speed up convergence by increasing the number of events; the photon stream fed into an EDH that processes a 2×2 pixel block will have 4× the number of events (on average) than any individual pixel in that block. An example of a single EDH for a group of pixels is shown in FIG. 14.

Another nuance of the operation of a multi-binner EDH is the comparability of the control values of the different binners. Differences in fabrication may mean that the same CV for two binners leads to slightly different reference-signal delays. Various strategies may be applied to address this issue. In some aspects, a first strategy may include initial calibration, where a random stream of events (produced by an ambient light source such as an incandescent light illuminating the detector or a periodic stream of artificially generated events using a clock source) is fed via SR to an EDH, and the bin boundaries should converge to equally spaced positions. Those values may be stored for use during post-processing to adjust later read-outs. Another strategy is direct readout. While the CV values for binners in an EDH might not be directly comparable, the reference-signal delays are. Thus, in other aspects those signals may be read out and sent to a “time-to-digital” converter (either sequentially or in parallel) to produce comparable histogram boundaries. A still further strategy is joint readout, which is a variation on direct readout that takes the exclusive-or of all the reference signals of the binners in an EDH. The resulting joint signal will have a transition at each bin boundary. A transition detector in tandem with a fast counter might then process the joint signal and extract all the bin boundaries in one pass.

Background bias is much less of a problem in multi-stage EDH than with an isolated binner. As noted previously, high background level in the transient distribution can bias the boundary of a binner towards the middle of its range (which is where the boundary will converge with uniform background level). That bias can be a problem when using a single binner in an application such as a “peak tracker”. However, background bias is much less of an issue for an EDH. The reason is that “side bins” away from a peak “absorb” many of the background events in the distribution, and a cluster of bins around the peak(s) of the transient distribution still align well with those peaks. As an example of this effect, consider FIGS. 9A-9D which shows the output of a four-stage EDH (with 16 bins), along with the actual transient distribution. FIG. 9A shows the low-background case, with only a few side bins, and bins clustered around the distribution peak at 615. FIG. 9C shows the high-background case. While there are more side bins in this case, there are still enough bins to resolve the range around the peak. The predicted peak positions for the two histograms (using a curve-fitting method described in more detail below) are 611.2 and 628.4 for the low- and high-background cases, respectively, both close to the true peak.

Thus, FIGS. 9A-9D show the effect of background light level on EDH bin widths. A 16-bin EDH correctly converges towards the true peak location in this simulated example for both low background light level (FIG. 9A) and high background light level (FIG. 9C). In case of low background, about 10 of the 16 EDH bins are clustered around the peak. In the high-background case, the EDH needs additional bins to absorb the background events; about 7 of the 16 EDH bins cluster around the peak. Blown-up views of the plots of FIG. 9A and FIG. 9C are shown in FIG. 9B and FIG. 9D, respectively, with the narrowest bin locations highlighted. FIG. 9B shows a tighter distribution of bin boundaries around the main peak than in FIG. 9D. The narrowest bin (vertical speckled strip) is approximately in the same location, the only difference is that in the low background case (FIG. 9B), the narrowest bin is narrower than in the high background case (FIG. 9D).

FIGS. 10 and 11 show example distance maps (e.g., depth maps) that may be generated of imaged scenes using the EDHs described herein. FIG. 10 shows single-photon 3D imaging with 8-bin ED histograms (EDH). FIG. 10 includes two images, a first image 1002 which is a grayscale version of an RGB image of a rendered “kitchen” scene and a second image 1004, which is a grayscale version of an RGB image of a rendered “dining” scene. FIG. 10 includes a plurality of distance maps for each imaged scene. Distance maps 1006 and 1008 are ground truth distance maps (e.g., distance map 1006 is a ground truth distance map for the kitchen scene imaged in the first image 1002 and distance map 1008 is a ground truth distance map for the dining scene imaged in the second image 1004). The rendered kitchen and dining scenes may be generated using a 3D model, which includes information on material texture, reflectivity and transparency, along with existing sources of illumination. The ground truth distance maps generated from these 3D models may represent the “true” distance of the objects in the rendered scenes. In some aspects, the ground-truth distance maps may be at a resolution of 0.25 cm (2000 units over a maximum range of 5 m).

Distance maps 1010 and 1012 show distance of the kitchen scene and dining scene, respectively, reconstructed using a naive coarse histogram method that uses 8 EW bins. Distance maps 1014 and 1016 are the distance maps of the kitchen scene and dining scene, respectively, obtained with 8-bin EDH, as described herein, and show that reliable distance reconstruction can be performed with just 8 ED bins. These distance maps (distance maps 1014 and 1016) were simulated with low background light and no averaging or post-processing, using the midpoint of the narrowest bin to estimate peak locations. Post-processing may further improve distance map quality. (Distance maps 1006, 1008, 1010, 1012, 1014, and 1016 have the same scale from 0 to 5 meters.)

As appreciated from FIG. 10, the correspondence of the distance maps generated with EDH (distance maps 1014 and 1016) with the ground truth is quite good. In some aspects, any graininess may be reduced via temporal or spatial averaging. In contrast, the distance maps generated with a conventional 8-bin EWH per pixel (distance maps 1010 and 1012) capture much less detail of the scene, and introduce some edge artifacts (such as the window in distance map 1012). Additionally, the EWH distance map 1012 has visible discrete steps due to low histogram resolution.

FIG. 11 shows the same image of the rendered kitchen scene (first image 1002) and the same ground truth distance map (distance map 1006) as shown in FIG. 10. However, in FIG. 11, the EWH distance map (distance map 1102 of FIG. 11) and the EDH distance map (distance map 1104 of FIG. 11) were generated with 16 bins rather than the 8 bins of FIG. 10.

Thus, FIGS. 10 and 11 show that both the 8 bin EDH and the 16 bin EDH generate distance maps that are more accurate than the distance maps produced with an EWH with the same number of bins. The decision of how many bins to generate with an EDH may be based on various factors including the scene being imaged. For example, as the number of stages hence bins-increases, the widths of the bins around a peak get narrower, which may make resolving their boundaries difficult. On the other hand, with too few bins, there may not be enough bins to capture all peaks, especially in the presence of high background levels. At least in some examples, 16 bins (as generated by a four-stage EDH, for example) may be applied for distance mapping interior scenes, and 8 bins (as generated by a three-stage EDH, for example) may be applied for distance mapping of close-up scenes.

Additionally, there may be situations where high resolution is desired, such as close peaks (that can arise with transparent surfaces such as window glass) or a highly reflective surface generating multiple peaks from different return paths. Such cases may be addressed by adding more stages to the EDH, each doubling the number of binners.

FIG. 12 is a flow chart illustrating an example method 1200 for identifying a bin boundary of a transient distribution using a binner. Method 1200 is described with regard to the systems and components of FIGS. 1 and 2A and/or 7, though it should be appreciated that the method 1200 may be implemented with other systems and components without departing from the scope of the present disclosure.

At 1202, method 1200 includes transmitting pulsed light at a commanded frequency. The pulsed light may be transmitted from a suitable light source, such as a laser (e.g., light source 102 of FIG. 1). The transmitted light may reflect off objects in the scene that are to be imaged. At 1204, a stream of return events (SR) is received at a binner (such as binner 200 of FIG. 2). As explained previously, the binner is coupled to at least one pixel of a single-photon detector. The pixel of the detector generates voltage pulses each time a photon impinges on the pixel, and the voltage pulses are received at the binner as the SR.

The light source may be pulsed at the commanded frequency over a plurality of cycles (e.g., where each cycle corresponds to one pulse). The binner may receive the SR over the plurality of cycles. For the first cycle of the plurality of cycles, the binner may generate, via a reference signal generator, a reference signal (RS) that has a waveform with a high value that extends for an initial duration, as indicated at 1206. The initial duration may be a default duration, such as the midpoint of a window, or another suitable duration, for example, using the CV from a previous run, though additional durations are also contemplated. At 1208, the SR is split by two AND gates of the binner into two output streams, SE and SL, based on RS. SE is a stream of early events and SL is a stream of late events. The early events are defined as occurring while the RS waveform is at the high value and the late events are defined as occurring while the RS waveform is at the low value (where the high value is defined as being higher than the low value). At 1210, a control value (CV) is adjusted based on the number of events (in the first cycle) classified as early events (e.g., the number of events in SE) relative to the number of events classified as late events (e.g., the number of events in SL). As a non-limiting example, the CV may be initialized at an initial value and then decremented by one unit for each early event and incremented by one unit for each late event. The CV may be an integer within a range of time units of the cycle. For example, the cycle may correspond to a window having a plurality of time units, where the time unit may be 128 picoseconds and the CV may be an integer in a range of 1-1024 (such that the cycle has a total duration equal to 1024 of the time units). At 1212, the RS is adjusted based on the CV. For example, if the CV decreases from the initial value by a given number of time units, the duration of the high value of the waveform of the RS is decreased by the same number of time units.

The same process is then repeated for each additional cycle of the plurality of cycles. At the beginning of the additional cycle (corresponding to the beginning of the next light pulse), a new RS is generated that has the adjusted duration, as indicated at 1214 (e.g., where the duration is adjusted based on the CV of the prior cycle). The SR is split into SE and SL based on RS, as indicated at 1216, and the CV is again adjusted based on the number of events in SE relative to SL, as indicated at 1218. The RS duration for the next cycle is adjusted based on the adjusted CV, as indicated at 1220. In this way, the CV and hence the RS are adjusted at each cycle until the CV (and hence RS) converges at or near the target quantile (e.g., the median for a median-binner or another quantile for a proportional binner) of the distribution of the time delays (from the beginning of a respective light pulse) of the photons impinging on the detector pixel.

At 1222, the value of the CV is read out when requested. The CV may be read out at any point during the run, such as at the end of the run (e.g., after the last cycle) or one or more times during the run. If the CV is read out more than once during the run, the different readouts may be averaged to determine the final CV. The lower the signal strength and the higher the background-light levels, the larger and longer the excursions will be away from the median once it is reached. Thus, when taking multiple readouts for averaging, the number and/or spacing of the readouts may be adjusted based on signal and/or background levels. The CV may be used to determine the distance of the object being imaged by the pixel. Because the CV represents a number of time units, the CV may be multiplied by the time unit (e.g., 128 picoseconds) and this value may be used along with the speed of light to determine the distance that the photons traveled to reach the pixel, which is the distance value of the object. Method 1200 then ends.

It should be appreciated that method 1200 may be carried out for each pixel of the detector, using a respective binner coupled to each pixel or group of pixels, such that a distance value is determined for each pixel or group of pixels. These distance values may be used to construct a distance map that is usable for various tasks. A single binner as described above with respect to FIG. 12 may be influenced by background light and thus may not identify the peak of the distribution as accurately as an equi-depth histogrammer. Thus, when using a single-stage binner to identify distance values to generate a distance map, the final CV output by the binner may be adjusted based on the background light, which may be measured by the detector when no light pulses from the light source are occurring, as explained previously. However, to improve accuracy of the distance determination, an equi-depth histogrammer may be used, as described below. In some examples, the method 1200 may be applied to a binner of an equi-depth histogrammer, and the SE and SL split by the binner as described above may be fed to respective binners of a second stage of the equi-depth binner.

FIG. 13 is a flow chart illustrating an example method 1300 for identifying a plurality of bin boundaries of a transient distribution using a histogrammer with multiple binners (e.g., an EDH). Method 1300 is described with regard to the systems and components of FIGS. 1 and 2A and/or 7, though it should be appreciated that the method 1300 may be implemented with other systems and components without departing from the scope of the present disclosure.

At 1302, method 1300 includes transmitting pulsed light at a commanded frequency. The pulsed light may be transmitted from a suitable light source, such as a laser (e.g., light source 102 of FIG. 1). The transmitted light may reflect off objects in the scene that are to be imaged. At 1304, a stream of return events (SR) is received at a first stage binner (such as binner BN1 of FIG. 7) of a multi-stage histogrammer. As explained previously, the multi-stage histogrammer is coupled to at least one pixel of a single-photon sensing detector. The pixel of the detector generates voltage pulses each time a photon impinges on the pixel, and the voltage pulses are received at the first stage binner as the SR. The light source may be pulsed at the commanded frequency over a plurality of cycles (e.g., where each cycle corresponds to one pulse). The first stage binner may receive the SR over the plurality of cycles.

At 1306, method 1300 includes setting a bin boundary for the first stage by adjusting the CV and RS over a first set of cycles. The first set of cycles may be a suitable number of cycles, such as the first 500 cycles. To set the first bin boundary, the CV may be adjusted as described above with respect to FIG. 12, e.g., the return events may be split into two streams SE and SL and the CV adjusted at each cycle based on the number of events in SE and SL. The CV may modulate the waveform duration of the RS at each cycle.

At 1308, the first stage is frozen after the first set of cycles. When the first stage is frozen, the bin boundary identified by the first stage binner (e.g., the CV at the end of the first set of cycles) is set as the first bin boundary and the first bin boundary is no longer adjusted. The SR is still received at the first stage binner and is split into SE and SL, which are then fed to respective binners of a second stage of the multi-stage histogrammer, as indicated at 1310. The respective binners of the second stage may be binners BN1.1 and BN1.2 of FIG. 7, for example.

At 1312, the bin boundaries for the second stage are set by adjusting the CV and RS for each binner of the second stage over a second set of cycles. The second set of cycles may include the same number of cycles of the first set of cycles (e.g., 500) and may occur immediately after the first set of cycles (e.g., the second set may include cycles 501-1000). The CV and RS may be adjusted as explained above (e.g., where each binner splits the incoming stream into SE and SL and adjusts the CV and hence the RS based on the number of events in SE and SL). At 1314, the bin boundaries identified by the binners of the second stage are frozen after the second set of cycles is complete (e.g., at cycle 1000). At 1316, the process is repeated for each additional stage (if any) of the multi-stage histogrammer. For example, if the multi-stage histogrammer includes three stages, the SE and SL streams from each binner of the second stage may be fed to respective binners of the third stage (which may include four binners), to thereby identify four additional bin boundaries (for a total of 7 bin boundaries). If the multi-stage histogrammer includes four stages, the SE and SL streams from each binner of the third stage may be fed to respective binners of the fourth stage (which may include eight binners), to thereby identify eight additional bin boundaries (for a total of 15 bin boundaries). At 1318, the CVs (one from each binner) may be readout when requested, such as at the end of the run (e.g., after the final stage is frozen/complete). Each CV may represent a bin boundary, and the bin boundaries may be used to identify one or more peaks in the distribution, as indicated at 1320. For example, the distribution may include one peak that is indicative of the distance of the imaged object/point and the peak may be identified from the bin boundaries. Thus, the output of an EDH may be used to estimate the position(s)/location(s) of the peak(s) in the transient distribution for a pixel. In the single-binner case, the median boundary itself provides that estimate. However, in a multi-bin EDH, a “locally narrow” bin generally marks a peak, where a locally narrow bin is narrower than its adjacent bin(s). Since the narrowest bin still has width, a further calculation may be performed to produce an estimated peak location. Two methods may be applied for producing such an estimate: bin midpoint and curve fitting. The bin midpoint method simply uses the midpoint of a locally narrow bin as the peak estimate. For example, suppose the EDH includes K stages giving 2^{K}−1 bin boundaries D[1, 2, 3, . . . , 2^{K}−1]. The first and last bin edges are, by definition, located at the extreme ends of the time window, i.e.

$$D [ 0 ] = 0 and D [ {2}^{K} ] = T . Let {i}^{*} = arg {max}_{1 \leq i \leq {2}^{K}} \frac{1}{D [ i ] - D [ i - 1 ]}$$

be the right edge of the narrowest bin. The “argmax” distance estimator is the midpoint of the narrowest ED bin:

$${\hat{d}}_{argmax} {=}^{def} \frac{c}{4} ( D [ {i}^{*} ] - D [ {i}^{*} - 1 ] )$$

where c is the speed of light. This method of distance estimation may be extended to handle multiple peaks (e.g., due to multiple reflections, or presence of semi-transparent materials along the viewing direction) by replacing the argmax operation by a more general peak finding routine which may return locations of all “locally narrow” bins (those narrower than adjacent bins).

While simple, the bin midpoint method has the limitation that real-life peaks tend not to be symmetric, which can pull the narrow bin to one side of the peak. The curve-fitting method fits a curve through bins in the vicinity of a narrow bin (including the narrow bin), then uses the location of the maximum of that curve as the peak estimate. To fit a curve, bins may be converted to (x,y)-points by taking the bin midpoint as the x-value, and the bin “density” as the y-value, which can be computed as p/w, where p is the bin population and w is the bin width. In some examples, since all bins have the same population, and only the location of the maximum is being sought, bin Bᵢ may be represented as (mᵢ, 1/wᵢ), where mᵢ is the midpoint of bin Bᵢ. Polynomial curve fitting may be used to fit, but other functions to fit that might deal with the asymmetry of peaks are possible.

Thus, a peak location may be estimated by fitting a curve to the points corresponding to multiple bins. Fitting a curve may include fitting a quadratic curve to the points corresponding to three bins or by fitting a Gaussian pulse shape to the points corresponding to three or more bins. In some examples, the peak location may be estimated using a template-matching technique such as cross-correlation, normalized cross-correlation, or a matched filter with the known laser pulse shape used as the template. The quadratic curve fitting method may provide finer estimates of the peak location. Denoting xᵢ=(D[i]−D[i−1])/2 and yᵢ=1/D[i]−D[i−1], a quadratic y=αx²+βx+γ may be fit using the (xᵢ, yᵢ) pairs for ED histogram bin indexes surrounding the narrowest bin. The number of bins on either side of the narrowest bin is chosen adaptively to lie within one-standard deviation of all the ED bin widths. In some examples, this results in a subset of the bins {i*−2, i*−1, i*, i*+1, i*+2}being chosen for curve fitting. The scene distance may be estimated using:

$${\hat{d}}_{curvefit} = - \frac{c β}{4 α} .$$

In some examples, when using a single EDH readout for estimating distance, the quadratic curve fitting method may result in a relatively wide spread in mean absolute error values, which may be due to the fluctuations in the binner outputs (e.g., if the binner outputs do not precisely line up around the peak location, the curve fitting can “amplify” the error further). This effect can be avoided by averaging multiple measurements.

The energy associated with peaks in the transient distribution (and with the distribution overall) may indicate parameters in addition to distance of an object, such as surface composition and pose. Current methods employing single-photon cameras for measuring reflectivity typically involve counting. However, the EDH approach described herein specifically avoids counting return events and thus only the relative peak strengths within a histogram are known; peak strengths between pixels are not comparable. While a counting circuit could be included to perform, for example, an overall count of return events per pixel, the counting circuit may add extra complexity and power usage. Thus, a simple extension of the EDH may be applied that may supply a comparable “yardstick” for each pixel. For example, the binner circuit may be utilized for intensity estimation by using the binner's register memory as a passive photon counter. As another example, an artificial event may be injected at “pseudotime” 0 into an EDH on every cycle, thus creating a peak of known strength. Then bin 1 would have an equivalent “energy” across pixels, so the width of bin 1 may be used to calibrate bin widths for actual peaks in the transient distribution. Such an approach may consume a bin, thus providing lower resolution for the actual transient distribution. Further, if there is a true peak near 0, some of the peak's energy might “bleed” into bin 1. However, despite these potential drawbacks, the advantage of the technique is its simplicity, as there is already a signal marking the start of every cycle going to each binner that can be employed (perhaps with a slight delay) as the simulated return event.

The number of bins that the EDH is configured to identify may be calibratable (e.g., 4 bins, 8 bins, 16 bins, etc.). As the number of bins in the EDH increases, the widths of the bins around a peak get narrower, which may make boundary resolution more difficult. On the other hand, with too few bins, there may not be bins enough to capture all peaks, especially in the presence of high background levels. In some examples, 16 bins (such as produced by a four-stage EDH) may be used for distance mapping interior scenes, and 8 bins (such as produced by a three-stage EDH) may be used for distance mapping close-up scenes. However, there may be situations where more resolution is needed, such as close peaks (that can arise with transparent surfaces such as window glass) or a highly reflective surface generating multiple peaks from different return paths. In some examples, to address issues of complexity that arise by adding extra bins while still allowing for capture of all peaks, a “zooming” process may be applied to zoom in on a subrange of the return distribution, which is explained in more detail below.

Some of the examples that have been provided herein utilize a window size of 1024 units of 128 picoseconds each. However, window size is somewhat arbitrary (though there are physical limits to the smallest time-unit on delays that can be realized). The maximum distance to be captured may determine the length of a window (and the power of the laser used). The defaults in prior examples have generally been a window of 1024 units of 128 ps each, which corresponds to a maximum distance of about 20 m. If instead the window size was set so that there are 1500 units in a window, the maximum distance would be nearly 30 m.

Using a 1000-unit window as an example, with a strongly reflecting surface at 24 meters (what would be a peak at 1200 units in a 1500-unit window) and assuming that one cycle starts immediately after the previous one, pulses reflected from that surface will show up at roughly the 200-unit mark of the following window. To an EDH, that peak appears no different than a peak of similar strength at the 200-unit distance. This example illustrates the aliasing problem: a peak that falls outside the window at N units appears as an “in-window” peak at N−k·(window length) units, for some integer k. In the example, k is 1 and the 1200-unit peak appears as an in-window 1200−1·1000=200-unit peak. This simple formula provides an approach to “de-aliasing”: if the window length is increased, a true peak will appear in the same place, whereas an “alias” peak will shift forward by a number of units that is a multiple of the difference in window lengths. If the previous position of an alias peak is N−k·(window length), then its new position will be N−k·(new window length). Thus it will have shifted forward by k·((new window length)−(old window length)). Accordingly, an aliased peak will shift when the window duration is changed slightly while the true peak will stay in the same location.

For a given number of bins, there can be return distributions—or portions thereof—that an EDH cannot sufficiently resolve. For example, ED histograms of some distributions may exhibit limited bins converging on each peak, which is problematic for peak estimation and detecting the asymmetry of the weakest peak. In such cases, a subrange of the distribution may be zoomed in on, by filtering out return events outside that subrange. For example, an EDH of a transient distribution of 0-2000 may have actual peak positions of the two strong peaks at 985 and 1219.3. An original ED histogram may give estimates of 989.5 and 1214.5 via curve fitting. A zoomed histogram, generated using filtering (e.g., temporal gating signals implemented with race logic) to only accept photons returning over a zoomed-in subrange (in this case in a range 750-1400) that covers the first two peaks of interest, on the other hand, may give estimates of 988.2 and 1216, an improvement in both cases. Accordingly, when zooming, a first, non-filtered run may be performed to identify a subrange of the distribution. One or more subsequent runs may be performed with filtered input as described herein (e.g., to filter out events outside of the subrange). In some examples, the first run with non-filtered input and the subsequent run(s) may use differing numbers of binner stages in the multi-stage histogrammer, e.g., the first run may use all the binner stages while the subsequent run(s) may use less than all the binner stages.

When zooming, the subrange that is zoomed in on may be adjustable based on desired outcomes or imaging goals. If it is desired to more accurately determine a peak, or separate two nearby peaks, then the subrange may be set based on a locally narrow bin (or bins) plus a fixed number of bins or a certain interval in either direction. For example, suppose it is desired to determine the first two strong peaks in the multi-peak transient distribution of the example presented above. Two locally narrow bins may be identified at 980 and 1220. A subrange that covers these two peaks may be zoomed in on. In this case, for example, approximately one-and-a-half bins on either side of the two locally narrow bins may be zoomed in and provide refined shape estimates using subsequent runs of a 16-bin EDH. If it is desired to resolve a faint peak, then the range of the “wide” locally narrow bin, perhaps with a small added interval on either side of that bin, may be used.

Performing the zooming may include determining what subrange to zoom in for each pixel “off detector,” because of the amount of computation involved. For instance, simply determining which are the locally narrow bins may include arithmetic and comparison operations on every bin. Thus, values indicating the subranges for zooming may be sent back to the detector, which may demand additional circuitry and inbound bandwidth. Once the subrange is determined at a pixel, the stream SR of return events may be filtered down to the specified subrange. In some aspects, if the EDH is built from proportional binners that are adjustable, the proportional binners may be targeted to the range of interest. For example, suppose initially the component binners target the 10th, 20th, . . . , 90th percentiles, and it is desired to resolve the distribution in the 30th-50th percentile subrange. The binners may be re-targeted to the 32nd, 34th, . . . , 48th percentiles to divide that subrange into 10 bins. (Note that the locations of the 30th and 50th percentile boundaries may already be known.) In another example, a signal may be generated every cycle that goes high during the subrange for a pixel. Such a signal can be generated using a gating circuit and using race logic to AND this signal with SR. Further, a series of gating signals could be generated for a sequence of window subranges, such as 0-100, 50-150, 100-200, . . . , 900-1000. Each pixel may be provided with a single number indicating which subrange in the series it should run for (or a bit vector can be provided if it should explore multiple subranges.) Subranges can be swept linearly or adaptively.

An EDH will eventually converge on a zooming run, even if it is started with the initial boundaries used for regular runs. An initial bin boundary need not be within the zooming subrange—it will head toward the subrange because all of the return pulses it receives are on that side. However, convergence may be sped up if bin boundaries are initialized more intelligently. Spreading them out evenly through the zooming subrange might be close to ideal, which may be performed with an initial phase of random or regularly spaced synthetic background events.

Zooming around a strong peak may reach convergence in a time comparable to a regular run. A large proportion of the return pulses will lie in the subrange, and bin boundaries do not have far to move. Resolving a faint peak may take longer. There will necessarily be a smaller proportion of the return pulses in the subrange, because it contains a faint peak. Depending on how the subrange is chosen, it might be substantially wider than the strong-peak case, perhaps also contributing to convergence times on a zoom run.

In some examples, the ED histograms from the original and one or more zoomed runs may be combined. If the task is simply peak finding, then the zoomed runs might just replace the original run. However, for tasks that demand a representation of the full transient distribution, the situation is more complicated and the zoomed histograms may not simply be pasted into the original, as the bin depths are different.

FIG. 14 schematically shows a detector 1400 comprising a plurality of pixels arranged into rows/columns. While only a few pixels are shown, it is to be appreciated that the detector 1400 may include a million or more pixels. In the example shown in FIG. 14, the pixels are arranged into groups of pixels, termed macropixels (in the example shown, each macropixel has four pixels, though that number may vary). Each macropixel is coupled to a respective equi-depth histogrammer (e.g., the multi-stage histogrammer of FIG. 7, a single binner as shown in FIG. 2A, or a histogrammer having a different number of binners). For example, pixels 0-3 are coupled to a B-bin histogrammer (e.g., having any number of binners) via a multiplexer. The pixels may be controlled by row drivers and column drivers, as shown. The detector 1400 may receive signals from various devices. For example, the detector 1400 may receive inputs indicating the timing of the laser pulses. In some examples, the inputs may include target percentile(s) for proportional binners or other inputs that may be used to control the binners. The histogrammer may determine bin boundaries for each pixel in the macropixel sequentially, or the histogrammer may determine bin boundaries for the macropixel as a whole.

FIGS. 15 and 16 show example circuit diagrams of a binner that may be included in a histogrammer (e.g., the binner of FIG. 2A or a binner of the multi-stage histogrammer of FIG. 7), with the control value implemented in analog (shown in FIG. 15) or the control value implemented digitally (shown in FIG. 16). Referring first to FIG. 15, it shows a first circuit diagram 1500 for a binner. The binner includes a monostable multi-vibrator that generates the RS, which is fed along with the SR to a set of AND gates. Each AND gate is coupled to a respective capacitor and each capacitor is coupled to a difference amplifier, which in turn provides the input to an integrator. As explained previously, the AND gates, based on the RS, may split SR into SE and SL. Each time an event is passed through an AND gate, the capacitor is charged and then discharged to the difference amplifier, which outputs the difference between the capacitor charges to determine a proportionality of the SE and SL events (e.g., the CV) that provides an input to the integrator. The capacitors may be reset at desired timepoints, such as the end of each cycle (e.g., which is determined based on the clock signal input to the RS generator). Thus, the CV may be the output of the integrator. The CV is fed back to adjust the RS (e.g., set the duty cycle of the RS waveform). SE and SL may also be fed to buffer amplifiers and output to the next stage binner, when the binner is in a multi-stage histogrammer. In this way, the CV (also referred to as a reference signal modulator) is the output of an integrator that is coupled to a difference amplifier that is in turn coupled to a pair of capacitors, with each capacitor coupled to a respective AND gate that receives the RS and the SR. It is to be appreciated that when the binner is downstream of a prior binner, SR may be the SE or SL of the prior binner.

FIG. 16 shows a second circuit diagram 1600 of a binner, which includes some similar elements as the first circuit diagram 1500 (such as the reference signal generator and AND gates). Instead of capacitors and amplifiers, the CV may be implemented digitally with a 12-bit register. Each AND gate feeds into the register, which increments for each SE event and decrements for each SL event. The value of the register is the CV, which is output after each event detection or after a plurality of event detections (e.g., at the end of a window). As explained above, the CV is fed back to adjust the RS (e.g., set the duty cycle of the RS waveform) and SE and SL may also be output to the next stage binner.

A technical effect of the binner and equi-depth histrogrammer described herein is that scene distance information may be captured in a bandwidth- and energy-efficient manner. Using a binner—which adaptively finds a given quantile—as a basic building block, an equi-depth histogrammer may be generated that determines multiple bin boundaries without explicitly storing a history of photon counts. The binner is amenable to implementation with race logic, a technology that operates in the delay domain, which is well suited to processing return events at a single-photon pixel. This approach may reduce bandwidth while maintaining similar distance accuracy as existing resource-hungry methods that rely on storing and processing equi-width histograms with thousands of bins. An EDH-based SPC can achieve an energy savings of ˜10-100×, depending on various factors such as the number of laser pulses needed for convergence and energy consumption of each readout.

The disclosure also provides support for a method, comprising: receiving, at a binner, a stream of photon return events from a pixel of an imaging detector, the stream of photon return events generated by photons transmitted from a pulsed light source and reflected off an object in a scene, classifying, with the binner, each photon return event as either an early event or a late event based on a reference signal controlled by a control value, the control value configured to change based on a relative proportion of early events to late events, and outputting, from the binner, the control value upon request, the control value usable to determine a distance of the object in the scene. In a first example of the method, each photon return event comprises a time delay of a voltage pulse generated by the pixel relative to a pulse time of the pulsed light source, and wherein the control value is represented as an analog quantity or as a numeric register. In a second example of the method, optionally including the first example, classifying each photon return event as either an early event or a late event based on the reference signal comprises classifying each photon return event that has a time delay smaller than a duration of the reference signal as an early event and classifying each photon return event that has a time delay larger than the duration of the reference signal as a late event. In a third example of the method, optionally including one or both of the first and second examples, the method further comprises: increasing the control value for each late event detected and decreasing the control value for each early event detected. In a fourth example of the method, optionally including one or more or each of the first through third examples, the method further comprises: increasing the control value based on a number of late events detected over one or more cycles of the pulsed light source and decreasing the control value based on a number of early events detected over the one or more cycles of the pulsed light source. In a fifth example of the method, optionally including one or more or each of the first through fourth examples, the stream of photon return events is received over a first cycle, and further comprising at an end of the first cycle, adjusting the duration of the reference signal based on a current control value, receiving a second stream of photon return events from the pixel over a second cycle, and classifying each photon return event in the second stream as either an early event or a late event based on the adjusted duration of the reference signal. In a sixth example of the method, optionally including one or more or each of the first through fifth examples, the control value is output after a plurality of streams of photon return events over a plurality of cycles has been received, the plurality of cycles defining a run. In a seventh example of the method, optionally including one or more or each of the first through sixth examples, the control value is adjusted by a fixed amount for each early event and late event across each cycle of the run. In an eighth example of the method, optionally including one or more or each of the first through seventh examples, the control value is adjusted by an amount that varies across two or more cycles of the run. In a ninth example of the method, optionally including one or more or each of the first through eighth examples, the control value is adjusted so that the control value converges towards a median of a distribution of all photon return events in the run. In a tenth example of the method, optionally including one or more or each of the first through ninth examples, adjusting the control value comprises, for the first cycle of the plurality of cycles, adjusting the control value from an initial value, wherein the initial value is one or more of: a midpoint of a range of an expected distribution of the photon return events, identified by starting the binner on a random event stream, based on a previous run of the binner, and based on a second run of a second binner for another pixel of the imaging detector. In a eleventh example of the method, optionally including one or more or each of the first through tenth examples, the binner is a first binner, and further comprising outputting a first stream of early events to a second binner and outputting a second stream of late events to a third binner, and reading out respective additional control values from the first binner, the second binner, and the third binner to derive values corresponding to boundaries of a histogram, the histogram used to determine the distance of the object. In a twelfth example of the method, optionally including one or more or each of the first through eleventh examples, the method further comprises: estimating a location of a peak in a distribution of photon return events over a run based on the histogram, the run including a plurality of cycles, each cycle including reception of a respective stream of photon return events generated by photons transmitted from a respective pulse of the pulsed light source, and wherein the peak is used to determine the distance of the object. In a thirteenth example of the method, optionally including one or more or each of the first through twelfth examples, estimating the location of the peak comprises estimating the location of the peak from a midpoint of a locally narrow bin of the histogram or estimating the location of the peak by fitting a curve to a plurality of points corresponding to multiple bins of the histogram.

The disclosure also provides support for a system, comprising: a single-photon counting detector comprising a plurality of pixels, the plurality of pixels including a first pixel, a binner coupled to the first pixel and including a reference signal generator, a reference signal modulator, a first gate, and a second gate, wherein a stream of photon return events generated by the first pixel and a reference signal generated by the reference signal generator are each fed to the first gate and the second gate to generate an early stream of photon return events and a late stream of photon return events, and wherein the reference signal modulator is configured to adjust a duration of the reference signal generated by the reference signal generator based on a relative proportion of the early stream of photon return events to the late stream of photon return events. In a first example of the system, the binner is a first binner in a first stage of a multi-stage histogrammer, and the multi-stage histogrammer further comprises a second stage including a second binner and a third binner, and wherein the second binner is configured to receive the early stream of photon return events and the third binner is configured to receive the late stream of photon return events. In a second example of the system, optionally including the first example: the early stream of photon return events is a first early stream, the late stream of photon return events is a first late stream, the reference signal modulator is a first reference signal modulator, and the reference signal is a first reference signal, the second binner is configured to generate a second early stream and a second late stream and includes a second reference signal modulator configured to adjust a second duration of a second reference signal generated by the second binner based on a relative proportion of the second early stream to the second late stream, and the third binner is configured to generate a third early stream and a third late stream and includes a third reference signal modulator configured to adjust a third duration of a third reference signal generated by the third binner based on a relative proportion of the third early stream to the third late stream. In a third example of the system, optionally including one or both of the first and second examples, the first reference signal modulator adjusts the duration of the first reference signal based on a first control value, the second reference signal modulator adjusts the duration of the second reference signal based on a second control value, and the third reference signal modulator adjusts the duration of the third reference signal based on a third control value, wherein the first control value, the second control value, and the third control value are read out to determine boundaries of a histogram, the histogram usable to determine a distance of a point in a scene. In a fourth example of the system, optionally including one or more or each of the first through third examples, the binner is coupled to a second pixel of the plurality of pixels.

The disclosure also provides support for a method for a single-photon sensing imaging system, comprising: generating a distance map of a scene based on a plurality of equi-depth histograms, each equi-depth histogram generated for a respective pixel of a plurality of pixels of a detector of the single-photon sensing imaging system, each equi-depth histogram including a plurality of bins having a same number of photon return events, and each photon return event partitioned into a bin of the plurality of bins based on a delay time of that photon return event, and displaying the distance map and/or using the distance map to generate and/or position one or more images for display.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the systems described above with respect to FIG. 1. The methods may be performed by executing stored instructions with one or more logic devices (e.g., processors) in combination with one or more hardware elements, such as storage devices, memory, hardware network interfaces/antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used herein, the terms “system” or “module” or “modulator” may include a hardware and/or software system that operates to perform one or more functions. For example, a module or system may include a computer processor, controller, or other logic-based device that performs operations based on instructions stored on a tangible and non-transitory computer readable storage medium, such as a computer memory. Alternatively, a module or system may include a hard-wired device that performs operations based on hard-wired logic of the device. Various modules or units shown in the attached figures may represent the hardware that operates based on software or hardwired instructions, the software that directs hardware to perform the operations, or a combination thereof.

The foregoing described aspects depict different components contained within, or connected with different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” “third,” and so on are used merely as labels, and are not intended to impose numerical requirements or a particular positional order on their objects. The following claims particularly point out subject matter from the above disclosure that is regarded as novel and non-obvious.

1. A method, comprising:
receiving, at a binner, a stream of photon return events from a pixel of an imaging detector, the stream of photon return events generated by photons transmitted from a pulsed light source and reflected off an object in a scene;
classifying, with the binner, each photon return event as either an early event or a late event based on a reference signal controlled by a control value, the control value configured to change based on a relative proportion of early events to late events; and
outputting, from the binner, the control value upon request, the control value usable to determine a distance of the object in the scene.

2. The method of claim 1, wherein each photon return event comprises a time delay of a voltage pulse generated by the pixel relative to a pulse time of the pulsed light source, and wherein the control value is represented as an analog quantity or as a numeric register.

3. The method of claim 2, wherein classifying each photon return event as either an early event or a late event based on the reference signal comprises classifying each photon return event that has a time delay smaller than a duration of the reference signal as an early event and classifying each photon return event that has a time delay larger than the duration of the reference signal as a late event.

4. The method of claim 3, further comprising increasing the control value for each late event detected and decreasing the control value for each early event detected.

5. The method of claim 3, further comprising increasing the control value based on a number of late events detected over one or more cycles of the pulsed light source and decreasing the control value based on a number of early events detected over the one or more cycles of the pulsed light source.

6. The method of claim 3, wherein the stream of photon return events is received over a first cycle, and further comprising at an end of the first cycle, adjusting the duration of the reference signal based on a current control value, receiving a second stream of photon return events from the pixel over a second cycle, and classifying each photon return event in the second stream as either an early event or a late event based on the adjusted duration of the reference signal.

7. The method of claim 6, wherein the control value is output after a plurality of streams of photon return events over a plurality of cycles has been received, the plurality of cycles defining a run.

8. The method of claim 7, wherein the control value is adjusted by a fixed amount for each early event and late event across each cycle of the run.

9. The method of claim 7, wherein the control value is adjusted by an amount that varies across two or more cycles of the run.

10. The method of claim 7, wherein the control value is adjusted so that the control value converges towards a median of a distribution of all photon return events in the run.

11. The method of claim 7, wherein adjusting the control value comprises, for the first cycle of the plurality of cycles, adjusting the control value from an initial value, wherein the initial value is one or more of:
a midpoint of a range of an expected distribution of the photon return events;
identified by starting the binner on a random event stream;
based on a previous run of the binner; and
based on a second run of a second binner for another pixel of the imaging detector.

12. The method of claim 1, wherein the binner is a first binner, and further comprising outputting a first stream of early events to a second binner and outputting a second stream of late events to a third binner, and reading out respective additional control values from the first binner, the second binner, and the third binner to derive values corresponding to boundaries of a histogram, the histogram used to determine the distance of the object.

13. The method of claim 12, further comprising estimating a location of a peak in a distribution of photon return events over a run based on the histogram, the run including a plurality of cycles, each cycle including reception of a respective stream of photon return events generated by photons transmitted from a respective pulse of the pulsed light source, and wherein the peak is used to determine the distance of the object.

14. The method of claim 13, wherein estimating the location of the peak comprises estimating the location of the peak from a midpoint of a locally narrow bin of the histogram or estimating the location of the peak by fitting a curve to a plurality of points corresponding to multiple bins of the histogram.

15. A system, comprising:
a single-photon counting detector comprising a plurality of pixels, the plurality of pixels including a first pixel;
a binner coupled to the first pixel and including a reference signal generator, a reference signal modulator, a first gate, and a second gate, wherein a stream of photon return events generated by the first pixel and a reference signal generated by the reference signal generator are each fed to the first gate and the second gate to generate an early stream of photon return events and a late stream of photon return events, and wherein the reference signal modulator is configured to adjust a duration of the reference signal generated by the reference signal generator based on a relative proportion of the early stream of photon return events to the late stream of photon return events.

16. The system of claim 15, wherein the binner is a first binner in a first stage of a multi-stage histogrammer, and the multi-stage histogrammer further comprises a second stage including a second binner and a third binner, and wherein the second binner is configured to receive the early stream of photon return events and the third binner is configured to receive the late stream of photon return events.

17. The system of claim 16, wherein:
the early stream of photon return events is a first early stream, the late stream of photon return events is a first late stream, the reference signal modulator is a first reference signal modulator, and the reference signal is a first reference signal;
the second binner is configured to generate a second early stream and a second late stream and includes a second reference signal modulator configured to adjust a second duration of a second reference signal generated by the second binner based on a relative proportion of the second early stream to the second late stream; and
the third binner is configured to generate a third early stream and a third late stream and includes a third reference signal modulator configured to adjust a third duration of a third reference signal generated by the third binner based on a relative proportion of the third early stream to the third late stream.

18. The system of claim 17, wherein the first reference signal modulator adjusts the duration of the first reference signal based on a first control value, the second reference signal modulator adjusts the duration of the second reference signal based on a second control value, and the third reference signal modulator adjusts the duration of the third reference signal based on a third control value, wherein the first control value, the second control value, and the third control value are read out to determine boundaries of a histogram, the histogram usable to determine a distance of a point in a scene.

19. The system of claim 15, wherein the binner is coupled to a second pixel of the plurality of pixels.

20. A method for a single-photon sensing imaging system, comprising:
generating a distance map of a scene based on a plurality of equi-depth histograms, each equi-depth histogram generated for a respective pixel of a plurality of pixels of a detector of the single-photon sensing imaging system, each equi-depth histogram including a plurality of bins having a same number of photon return events, and each photon return event partitioned into a bin of the plurality of bins based on a delay time of that photon return event; and
displaying the distance map and/or using the distance map to generate and/or position one or more images for display.
